(19) United States
(12) Patent Application Publication
(10) Pub. No.: US 2012/0001948 A1
(43) Pub. Date: Jan. 5, 2012

(54) Display device, pixel circuit and display drive method thereof

(75) Inventors: Naobumi Toyomura, Kanagawa (JP); Katsuhide Uchino, Kanagawa (JP)

(73) Assignee: Sony Corporation, Tokyo (JP)

(21) Appl. No.: 13/067,275

(22) Filed: May 20, 2011

(30) Foreign Application Priority Data
Jul. 1, 2010 (JP) 2010-150797

(51) Int. Cl. G09G 3/30; G09G 5/10

(52) U.S. Cl. 345/690; 345/77

(57) ABSTRACT

A display device includes: a pixel array in which pixel circuits each having a light emitting device and a drive transistor which applies current corresponding to an inputted video signal voltage to the light emitting device are arranged in a matrix state; a signal selector supplying at least the video signal voltage and a reference voltage as signal line voltages to respective signal lines arranged in columns on the pixel array; a first write scanner outputting a first scanning pulse with respect to respective first write control lines arranged in rows on the pixel array, which is used for controlling input of the signal line voltages to the pixel circuits; and a second write scanner outputting a second scanning pulse with respect to respective second write control lines arranged in columns on the pixel array, which is used for controlling input of the signal line voltages to the pixel circuits with the first scanning pulse.

The present disclosure relates to a display device having a pixel array in which pixel circuits are arranged in a matrix state, a pixel circuit and a display drive method thereof, and for example, relates to a display device using an organic electroluminescent device (organic EL device) as a light-emitting device.

### BACKGROUND

Examples of the related art includes JP-A-2007-133282 (Patent. Document 1), JP-A-2003-255856 (Patent Document 2), JP-A-2003-271095 (Patent Document 3) and JP-A-2008-9198 (Patent Document 4).

An image display device using organic EL devices as pixels has been developed, for example, as shown in the above respective patent documents. As the organic EL device is a self-light emitting device, it has advantages such that the visibility of images is increased as compared with, for example, a liquid crystal display, that the backlight is not necessary and that response speed is high. Additionally, the luminance level (tone) of respective light emitting devices can be controlled by current values flowing in the devices (a so-called current control type).

The organic EL display has a simple matrix system and an active matrix system as drive systems as same as in a liquid crystal display. The former has problems such that it is difficult to realize a large-sized as well as high definition display though a structure thereof is simple, therefore, the active matrix system is vigorously developed at present. In the system, current flowing in light-emitting devices inside respective pixel circuits is controlled by active devices (generally thin-film transistors: TFTs) provided inside pixel circuits.

### SUMMARY

Incidentally, improvement of display quality is requested as a configuration of the pixel circuit using the organic EL device by eliminating luminance nonuniformity and so on in each pixel. Particularly, various configurations and operations of the pixel circuit in which variations of threshold voltage and mobility of a drive transistor in the pixel circuit are cancelled to eliminate luminance nonuniformity in each pixel are proposed for realizing a display panel having good uniformity.

Thus, it is desirable to realize a display device capable of correcting deterioration of uniformity more suitably, which is caused by, for example, variations of mobility and threshold voltage of the drive transistor applying current to the light emitting device.

An embodiment of the present disclosure is directed to a display device including a pixel array in which pixel circuits each having a light emitting device and a drive transistor which applies current corresponding to an inputted video signal voltage to the light emitting device are arranged in a matrix state, a signal selector supplying at least the video signal voltage and a reference voltage as signal line voltages to respective signal lines arranged in columns on the pixel array, a first write scanner outputting a first scanning pulse with respect to respective first write control lines arranged in rows on the pixel array, which is used for controlling input of the signal line voltages to the pixel circuits and a second write scanner outputting a second scanning pulse with respect to respective second write control lines arranged in columns on the pixel array, which is used for controlling input of the signal line voltages to the pixel circuits with the first scanning pulse.

The display device of this aspect may be configured such that the pixel circuit having a configuration in which the drive transistor applies current corresponding to a gate-source voltage to the light emitting device when a drive voltage is applied between drain/source, further includes a storage capacitor connected between the gate and the source of the drive transistor and storing the video signal voltage inputted from the signal line, and first and second switching devices connected in series between the signal line and a gate node of the drive transistor. The first switching device is turned on/off by the first scanning pulse and the second switching device is turned on/off by the second scanning pulse.

In this case, the signal line voltages are inputted to the gate node of the drive transistor by turning on both of the first and second switching devices by the first and second scanning pulses.

The display device of this aspect may be configured such that, in each pixel circuit, the video signal voltage is inputted by turning on both of the first and second switching devices by the first and second scanning pulses during a period in which the signal line voltage is in the video signal voltage, and a period of a mobility correction operation of the drive transistor performed at the time of inputting the video signal voltage is adjusted in each pixel circuit by adjusting a length of an on-period of the second switching device by the second scanning pulse with respect to an on-period of the first switching device by the first scanning pulse.

The display device of this aspect may be configured such that, in each pixel circuit, a threshold correction operation allowing the storage capacitor to store a threshold voltage of the drive transistor is performed by inputting the reference voltage to the gate node of the drive transistor when both of the first and second switching devices are turned on by the first and second scanning pulses as well as by applying the drive voltage to the drive transistor during a period in which the signal line voltage is in the reference voltage, and an execution period of the threshold correction operation is adjusted in each pixel circuit by adjusting a length of an on-period of the second switching device by the second scanning pulse with respect to an on-period of the first switching device by the first scanning pulse.

The display device of this aspect may be configured such that, in each pixel circuit, a threshold correction operation allowing the storage capacitor to store a threshold voltage of the drive transistor is performed by inputting the reference voltage to the gate node of the drive transistor when both of the first and second switching devices are turned on by the first and second scanning pulses as well as by applying the drive voltage to the drive transistor during a period in which the signal line voltage is in the reference voltage, and a source voltage and a gate voltage of the drive transistor are increased by providing a period in which the drive voltage is applied to the drive transistor, the first switching device is in an on-state by the first scanning pulse and the second switching device is in an off-state by the second scanning pulse just before the start of the threshold correction operation.

The display device of this aspect may be configured such that, in each pixel circuit, the video signal voltage is inputted by turning on both of the first and second switching devices by the first and second scanning pulses during a period in which the signal line voltage is in the video signal voltage, and a waveform of the second scanning pulse at the time of inputting the video signal voltage is a waveform in which a timing when the second switch device is turned off varies in accordance with video signal voltage values.

Another embodiment of the present disclosure is directed to a pixel circuit including a light emitting device, a drive transistor applying current corresponding to an inputted video signal voltage to the light emitting device, a storage capacitor connected between the gate and the source of the drive transistor and storing the video signal voltage inputted from the signal line, and first and second transistors connected in series between the signal line and a gate node of the drive transistor, in which a gate node of the first transistor is connected to gate nodes of the first transistors of the pixel circuits adjacent in the row direction, and a gate node of the second transistor is connected to gate nodes of the second transistors of the pixel circuits adjacent in the column direction.

Still another embodiment of the present disclosure is directed to a display drive method including controlling input of the signal line voltages to respective pixel circuits by cooperation of the first scanning pulse outputted to respective first write control lines arranged in rows on the pixel array and second scanning pulse outputted to respective second write control lines arranged in columns on the pixel array, and performing light-emitting drive operations of the light-emitting device by using the inputted video signal voltage and the reference voltage in respective pixel circuits.

In the above embodiments of the present disclosure, respective first write control lines arranged in rows on the pixel array and respective write control lines arranged in columns are provided, thereby supplying the first and second scanning pulse to respective pixel circuits. The input of the signal line voltages to respective pixel circuits is controlled by cooperation of the first and second scanning pulses. For example, when both the first and second switching devices are turned on by the first and second scanning pulses, the signal line voltages are applied to the gate node of the drive transistor.

In the above manner, respective pixel circuits are controlled by the pulse (first scanning pulse) supplied to respective pixel circuits in the row direction in common and the pulse (second scanning pulse) supplied to respective pixel circuits in the column direction in common. This means that input periods of the signal voltages to the pixel circuits can be controlled pixel by pixel.

According to the above, the mobility correction period, the threshold correction period and so on can be adjusted in respective pixel circuits. In other words, the optimum light-emitting drive operations corresponding to characteristics of respective pixels can be performed pixel by pixel.

According to the embodiments of the present disclosure, the optimum mobility correction period and the optimum threshold correction operation period can be set with respect to all pixel circuits, thereby performing suitable light-emitting drive operations in respective pixel circuits, which realizes display with high uniformity.

### BRIEF DESCRIPTION OF THE DRAWINGS

FIG. 1 is an explanatory diagram of a configuration of a display device according to an embodiment of the present disclosure;

FIG. 2 is a circuit diagram of a pixel circuit according to the embodiment;

FIG. 3 is a circuit diagram of a pixel circuit of a comparative example;

FIG. 4 is an explanatory diagram of pixel circuit operations of the comparative example;

FIGS. 5A and 5B are equivalent circuit diagrams in the process of a light-emitting operation of one cycle in the pixel circuit of the comparative example;

FIGS. 6A and 6B are equivalent circuit diagrams in the process of the light-emitting operation of one cycle in the pixel circuit of the comparative example;

FIGS. 7A and 7B are equivalent circuit diagrams in the process of the light-emitting operation of one cycle in the pixel circuit of the comparative example;

FIGS. 8A to 8C are explanatory diagrams of correction example in the comparative example;

FIG. 9 is an explanatory diagram of operations of a pixel circuit according to a first embodiment;

FIGS. 10A and 10B are equivalent circuit diagrams in the process of the light-emitting operations of one cycle according to the first embodiment;

FIGS. 11A and 11B are equivalent circuit diagrams in the process of the light-emitting operations of one cycle according to the first embodiment;

FIGS. 12A and 12B are equivalent circuit diagrams in the process of the light-emitting operations of one cycle according to the first embodiment;

FIG. 13 is an explanatory graph of adjustment of a mobility correction time according to the first embodiment;

FIG. 14 is an explanatory diagram of operations of the pixel circuit according to a second embodiment;

FIG. 15 is an explanatory graph of the difference of threshold correction amounts and γ-curve zero points;

FIG. 16 is an explanatory diagram of operations of the pixel circuit according to a third embodiment;

FIG. 17 is an explanatory diagram of operations of the pixel circuit according to a fourth embodiment;

FIG. 18 is an explanatory graph of the optimum correction time according to tones according to the fourth embodiment;

FIG. 19 is an explanatory graph of variations of correction time according to tones according to the fourth embodiment;

FIG. 20 is an explanatory diagram of operations of the pixel circuit according to a fifth embodiment;

FIG. 21 is an explanatory diagram of operations of the pixel circuit according to a sixth embodiment; and

FIG. 22 is a circuit diagram of a pixel circuit according to a modification example of the embodiment.

### DETAILED DESCRIPTION

Hereinafter, embodiments of the present disclosure will be explained in the following order.

1. Configuration of a display device and a pixel circuit according to an embodiment

2. Pixel circuit operations considered in the process to reach the present technology (Comparative example)

3. First Embodiment

4. Second Embodiment

5. Third Embodiment

6. Fourth Embodiment

7. Fifth Embodiment

8. Sixth Embodiment

9. Modification Example

### 1. Configuration of a Display Device and a Pixel Circuit

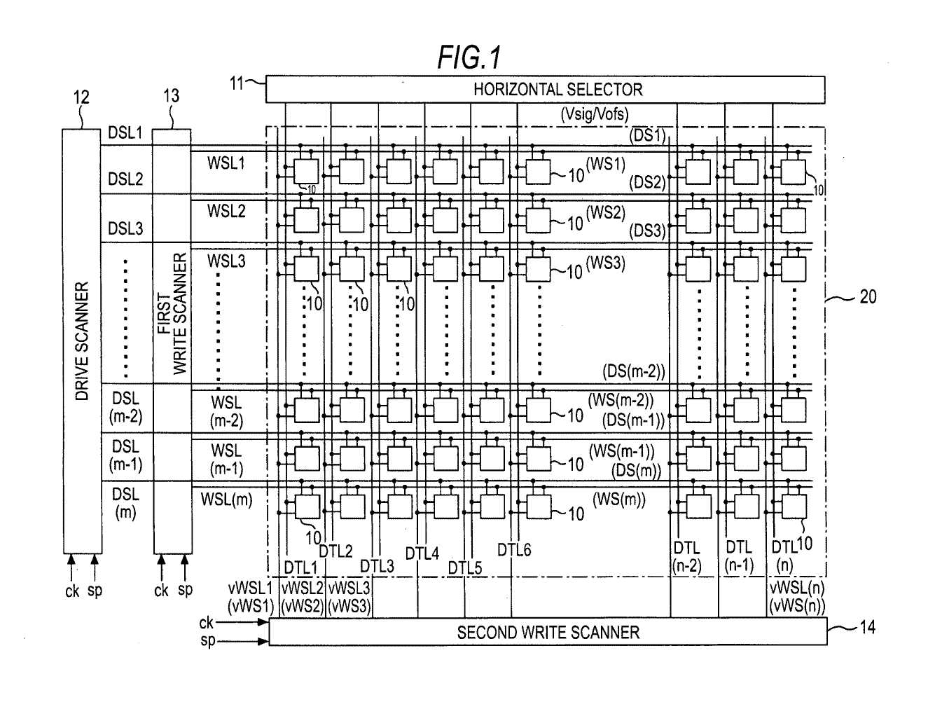

FIG. 1 shows a configuration of an organic EL display device according to an embodiment.

The organic EL display device includes pixel circuits 10 using organic EL devices as light emitting devices and being driven to emit light in an active matrix system.

As shown in the drawing, the organic EL display device has a pixel array 20 in which a large number of pixel circuits 10 are arranged in a matrix state in a column direction and a row direction (m-rows×n-columns). Each pixel circuit 10 is a light-emitting pixel of any of R (red), G (green) and B (blue), and pixel circuits 10 of respective colors are arranged in accordance with a given rule to form a color display device.

As a configuration for driving each pixel circuit 10 to emit light, a horizontal selector 11, a drive scanner 12, a first write scanner 13 and a second write scanner 14 are included.

Additionally, signal lines DTL1, DTL2 . . . DTL(n) to be selected by the horizontal selector 11 and supplying voltage

corresponding to signal values (tone values) of luminance signals as display data to the pixel circuits 10 are arranged in a column direction on the pixel array. The signal lines DTL1, DTL2 . . . DTL(n) are arranged so as to correspond to the number of columns (n-columns) of the pixel circuits 10 arranged in the matrix in the pixel array 20.

Also on the pixel array 20, first write control lines WSL1, WSL2 . . . WSL(m) as well as power supply control lines DSL1, DSL2 . . . DSL(m) are arranged in the row direction. The first write control lines WSLs and the power supply control lines DSLs are arranged so as to correspond to the number of rows (m-rows) of the pixel circuits 10 arranged in the matrix in the pixel array 20.

Further on the pixel array 20, second write control lines vWSL1, vWSL2 . . . vWSL(n) are arranged in the column direction. The second write control lines vWSLs are arranged so as to correspond to the number of columns (n-columns) of the pixel circuits 10 arranged in the matrix in the pixel array 20.

The first write control lines WSL1, WSL2 . . . WSL(m) are driven by the first write scanner 13.

The first write scanner 13 line-sequentially scans the pixel circuit 10 row by row by sequentially supplying first scanning pulses WS (WS1, WS2 . . . WS(m)) to respective first write control lines WSL1 to WSL(m) arranged in rows at set given timings.

The second write control lines vWSLs (vWSL1 to vWSL(n)) are driven by the second write scanner 14.

The second write scanner 14 supplies second scanning pulses vWS (vWS1, vWS2 . . . vWS(n)) to respective second write control lines vWSL1 to vWSL(n) arranged in columns at set given timings.

Voltage input of the signal lines DTL with respect to respective pixel circuits 10 is controlled by cooperation of the first scanning pulse WS and the second scanning pulse vWS.

The power supply control lines DSL (DSL1 to DSL(m)) are driven by the drive scanner 12. The drive scanner 12 supplies power control pulses DS (DS1, DS2 . . . DS(m)) to respective power control lines DSL1 to DSL(m) arranged in rows so as to correspond to the line-sequential scanning by the first write scanner 13. Power supply pulses DS (DS1, DS2 . . . DS(m)) are pulse voltage to be switched into two values which are a drive voltage Vcc and an initial voltage Vini.

The drive scanner 12, the first write scanner 13 and the second write scanner 14 set the timing of the power supply pulse DS, the first scanning pulse WS and the second scanning pulse vWS based on a clock “ck” and a start pulse “sp”.

The horizontal selector 11 supplies signal line voltages as input signals with respect to the pixel circuits 10 to the signal lines DTL1, DTL2 . . . arranged in the column direction so as to correspond to the line-sequential scanning by the first write scanner 13. In the present embodiment, the horizontal selector 11 supplies a video signal voltage Vsig which is a voltage corresponding to tones of video data and a reference voltage Vofs as signal line voltages in a time sharing manner. The reference voltage Vofs is used for, for example, the threshold correction operation.

In the display device according to the embodiment of the present disclosure, the horizontal selector 11 is an example of a signal selector and the first write scanner 13 is an example of a first write scanner and the second write scanner 14 is an example of a second write scanner.

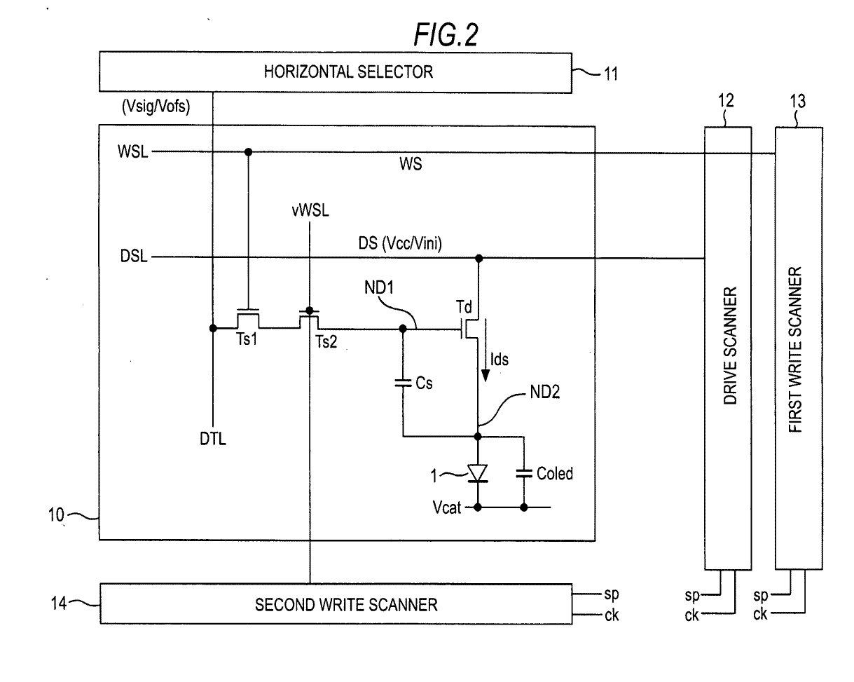

FIG. 2 shows a configuration example of the pixel circuit 10 according to the embodiment. The pixel circuits 10 are arranged in the matrix such as the pixel circuits 10 in the configuration of FIG. 1.

In FIG. 2, only one pixel circuit 10 arranged at an intersection between the signal line DTL, the second write control line vWSL and the first write control line WSL, the power supply control line DSL is shown for simplifying the drawing.

The pixel circuit 10 includes an organic EL device 1 as a light emitting device, a storage capacitor Cs, first and second sampling transistors Ts1, Ts2 and a drive transistor Td. A capacitor Coled is a parasitic capacitance of the organic EL device 1.

The sampling transistors Ts1, Ts2 and the drive transistor Td are formed by using an n-channel thin-film transistor (TFT).

One terminal of the storage capacitor Cs is connected to a source of the drive transistor Td (node ND2) and the other terminal thereof is connected to a gate of the same drive transistor Td (node ND1).

The light emitting device of the pixel circuit 10 is, for example, an organic EL device 1 having a diode structure, which includes an anode and a cathode. The anode of the organic EL device 1 is connected to a source of the drive transistor Td and the cathode is connected to given wiring (cathode voltage Vcat).

A source and a drain of the sampling transistors Ts1, Ts2 are connected in series between the signal line DTL and the gate of the drive transistor Td (Node ND1).

That is, one end of source/drain of the sampling transistor Ts1 is connected to the signal line DTL and the other end thereof is connected to the sampling transistor Ts2. One end of source/drain of the sampling transistor Ts2 is connected to the sampling transistor Ts1 and the other end thereof is connected to the gate of the drive transistor Td (node ND1).

Therefore, only when both of the sampling transistors Ts1, Ts2 are conductive, signal line voltages (video signal voltage Vsig/reference voltage Vofs) of the signal line DTL are inputted to the gate of the drive transistor Td.

A gate of the sampling transistor Ts1 is connected to the first write control line WSL corresponding to the row of the pixel circuit 10.

Therefore, a gate node of the sampling transistor Ts1 is connected to gate nodes of the sampling transistors Ts1 of respective pixel circuits 10 adjacent in the row direction in the pixel array 20 shown in FIG. 1.

On the other hand, a gate of the sampling transistor Ts2 is connected to the second write control line vWSL corresponding to the column of the pixel circuit 10.

Therefore, a gate node of the sampling transistor Ts2 is connected to gate nodes of the sampling transistors Ts2 of respective pixel circuits 10 adjacent in the column direction in the pixel array 20.

A drain of the drive transistor Td is connected to the power supply control line DSL.

The light emitting drive of the organic EL device 1 is basically performed as follows.

The sampling transistors Ts1, Ts2 become conductive by the first scanning pulse WS and the second scanning pulse vWS given from the first write scanner 13 and the second write scanner 14 through the first write scanning line WSL and the second write control line vWSL at a timing when the video signal voltage Vsig is applied to the signal line DTL. As a result, the video signal voltage Vsig from the signal line DTL is written into the storage capacitor Cs.

The drive transistor Td allows an electric current Ids to flow through the organic EL device 1 by current supply from the power supply control line DSL to which a drive voltage Vcc is given by the drive scanner 12 to thereby cause the organic EL device 1 to emit light.

At this time, the current Ids will be a value corresponding to a gate-source voltage Vgs of the transistor Td (value corresponding to the voltage stored in the storage capacitor Cs) and the organic EL device 1 emits light at luminance corresponding to the current value.

That is, in the case of the pixel circuit 10, the voltage to be applied to the gate of the drive transistor Td is changed by writing the video signal voltage Vsig from the signal line DTL into the storage capacitor Cs, thereby controlling the current values flowing into the organic EL device 1 and obtaining tones of light emission.

As the drive transistor Td is designed so as to operate in a saturation region constantly, the drive transistor Td will be a constant current source having a value shown in the following expression (1).

Ids=(1/2)·μ·(W/L)·Cox·(Vgs−Vth)² (1)

Note that Ids represents current flowing between the drain and the source of the transistor operating in the saturation region, μ represents mobility, W represents a channel width, L represents a channel length, Cox represents a gate capacitance and Vth represents a threshold voltage of the drive transistor Td.

As apparent from the expression (1), the drain current Ids is controlled by the gate-source voltage Vgs in the saturation region. The drive transistor Td operates as the constant current source and can allow the organic EL device 1 to emit light with a constant luminance as the gate-source voltage Vgs is maintained to be constant.

As described above, the operation of writing the video signal value (tone value) Vsig into the storage capacitor Cs of the pixel circuit 10 is performed in each frame period, as a result, the gate-source voltage Vgs of the drive transistor Td is determined in accordance with the tone to be displayed.

The drive transistor Td operates in the saturation region to function as the constant current source for the organic EL device 1 as well as allows current corresponding to the gate-source voltage Vgs to flow in the organic EL device 1 to thereby cause the organic EL device to emit light with a luminance corresponding to the tone value of the video signal in each frame period.

### 2. Pixel Circuit Operations Considered in the Process to Reach the Present Technology (Comparative Example)

Here, pixel circuit operations considered in the process to the present technology will be explained for comprehension of the technology. The operations indicate circuit operations including a threshold correction operation and a mobility correction operation for compensating deterioration of uniformity due to variations of the threshold and mobility of the drive transistor Td of each pixel circuit 10. As the threshold correction operation, an example of a divided threshold correction in which correction is made plural times by being divided in a period of one light emission cycle will be explained.

In the pixel circuit operations, the threshold correction operation and the mobility correction operation themselves have been heretofore performed, and necessity thereof will be briefly explained.

For example, in the pixel circuit using a polysilicon TFT and so on, the threshold voltage Vth of the drive transistor Td or the mobility μ of a semiconductor thin film forming a channel of the drive transistor Td may vary with time. Additionally, transistor characteristics such as the threshold voltage Vth and the mobility μ differ according to pixels due to variations in manufacture processes.

When the threshold voltage or the mobility of the drive transistor Td differs according to pixels, variations occur in current values flowing in the drive transistors Td in respective pixels. Accordingly, variations occur in light emitting luminance of the organic EL devices 1 in respective pixels even if the same video signal value (video signal voltage Vsig) is given to all pixel circuits 10, as a result, the uniformity of a screen is reduced.

In view of the above, the pixel circuit operations include a correction function with respect to variations of the threshold voltage Vth and the mobility μ.

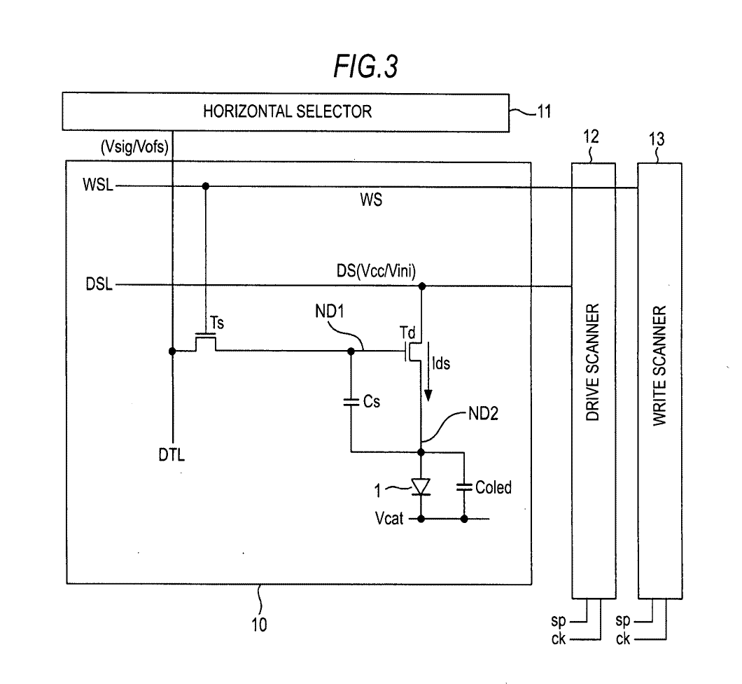

In this case, typical operations of the pixel circuit 10 shown in FIG. 3 will be explained.

The example differs from the pixel circuit 10 according to the embodiment shown in FIG. 2 in a point that the second sampling transistor Ts2 is not provided. The second write scanner 14 and the second write control line vWSL are not provided accordingly.

The basic light emitting operation by current application to the organic EL device 1 from the drive transistor Td is the same as the embodiment.

That is, a sampling transistor TS becomes conductive by the scanning pulse WS given from the write scanner 13 through the write control line WSL at the timing when the video signal voltage Vsig is applied to the signal line DTL. Accordingly, the video signal voltage Vsig from the signal line DTL is written into the storage capacitor Cs.

Then, the drive transistor Td operates in the saturation region to function as the constant current source for the organic EL device 1 and causes current Ids corresponding to the video signal voltage Vsig (gate-source voltage Vgs) written in the storage capacitor Cs to flow in the organic EL device 1. Accordingly, light emission corresponding to the tone value of the video signal is performed.

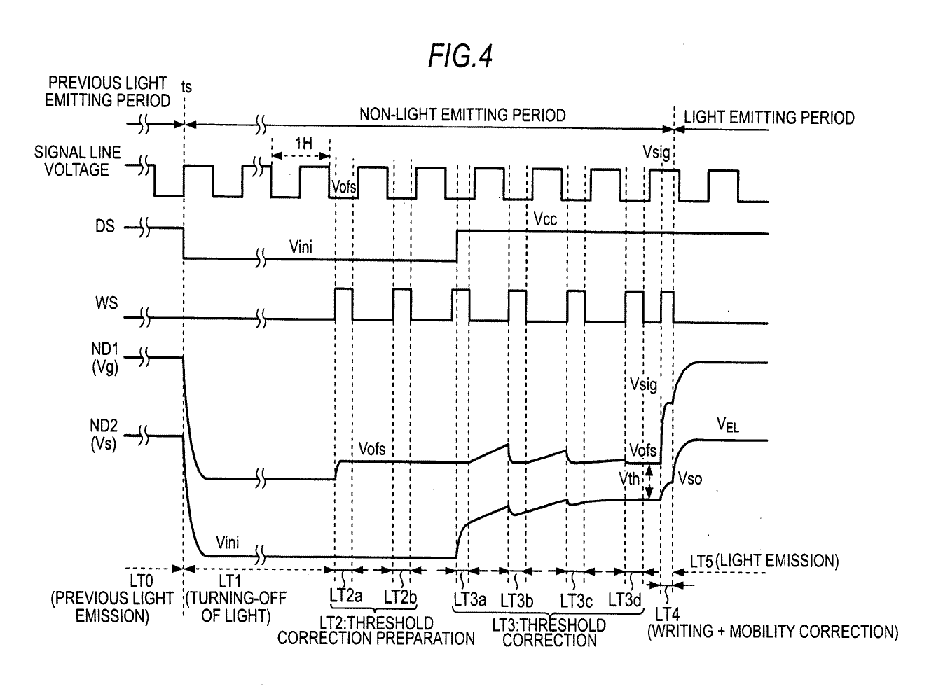

FIG. 4 shows a timing chart of operations in one light emission cycle (one frame period) of the pixel circuit 10.

In FIG. 4, the signal line voltages given to the signal line DTL by the horizontal selector 11 are shown. In the operation example, the horizontal selector 11 gives the pulse voltages including the reference voltage Vofs and the video signal voltage Vsig as the signal line voltages to the signal line DTL in one horizontal period (1H).

Also in FIG. 4, the power supply pulse DS supplied from the drive scanner 12 through the power supply control line DSL is shown. As the power supply pulse DS, the drive voltage Vcc or the initial voltage Vini is given.

Also in FIG. 4, the scanning pulse WS given to a gate of the sampling transistor Ts by the write scanner 13 through the write control line WSL is shown. The n-channel sampling transistor Ts becomes conductive when the scanning pulse WS is in an H-level, and becomes in nonconductive when the scanning

pulse WS is in an L-level.

Further in FIG. 4, variations of a gate voltage Vg and the source voltage Vs of the drive transistor Td as voltages of the nodes ND1, ND2 shown in FIG. 3 are shown.

A time point “ts” in the timing chart of FIG. 4 is a start timing of one cycle in which the organic EL device 1 as the light emitting device is driven to emit light, for example, one frame period of image display.

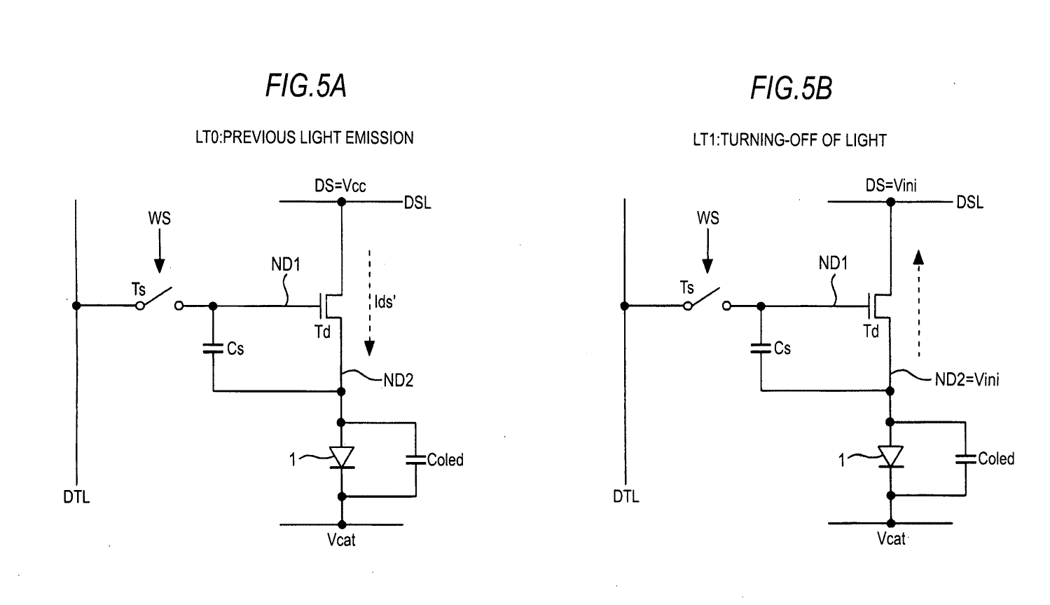

In a period before reaching the time point “ts” (period LT0), light emission in the previous frame is performed. An equivalent circuit in the period LT0 is shown in FIG. 5A.

That is, a light emitting state of the organic EL device 1 is a state in which the power supply pulse DS is in the drive voltage Vcc and the sampling transistor Ts is turned off. At this time, the drive transistor Td is set to operate in the saturation region, therefore, a current “Ids′” flowing in the organic EL device 1 will be a value shown in the above expression (1) in accordance with the gate-source voltage Vgs of the drive transistor Td.

At the time point “ts”, operations for light emission in the present frame are started.

First, the power supply pulse DC is applied in an initial potential Vini. FIG. 5B shows an equivalent circuit in a period LT1.

At this time, the initial potential Vini is smaller than the sum of a threshold voltage Vthe1 and the cathode voltage Vcat of the organic EL device 1, namely, Vini≦Vthel+Vcat, therefore, the organic EL device 1 is turned off and a non-light emitting period is started. At this time, the power supply control line DSL is a source of the drive transistor Td. The anode of the organic EL device 1 (node ND2) is charged to be the initial potential Vini.

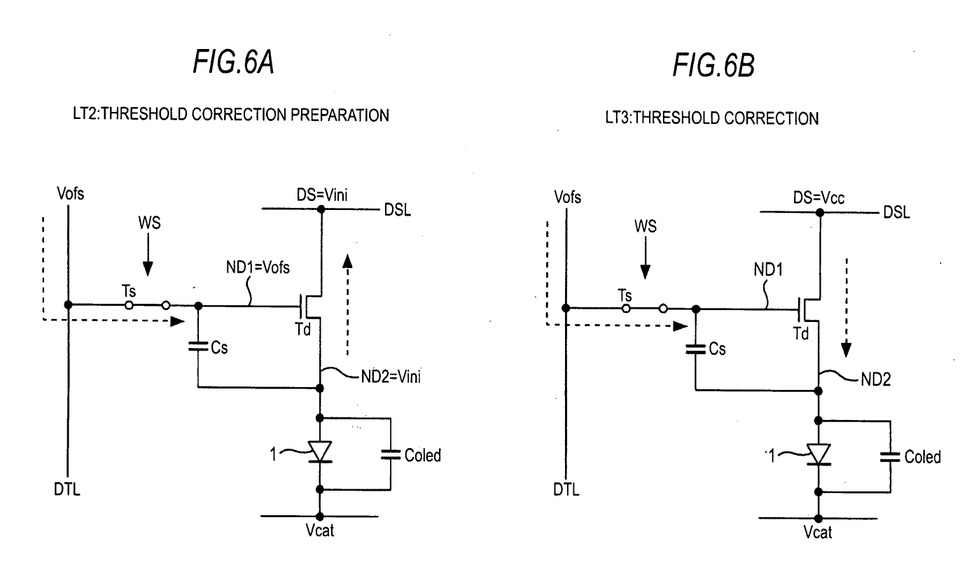

After a fixed period of time, a preparation for threshold correction is made (periods LT2a, LT2b). An equivalent circuit thereof is shown in FIG. 6A.

That is, in the periods LT2a, LT2b, the scanning pulse WS is in the H-level and the sampling transistor Ts is turned on when the potential of the signal line DTL is in the reference voltage Vofs.

Accordingly, the gate of the drive transistor Td (node ND1) is in the reference voltage Vofs.

The gate-source voltage of the transistor Td will be Vgs=Vofs−Vini.

It is difficult to perform the threshold correction operation unless Vofs-Vini is higher than the threshold voltage Vth of the drive transistor Td, therefore, the initial voltage Vini and the reference voltage Vofs are set so that Vofs-Vini is higher than Vth.

That is, the gate-source voltage of the drive transistor is sufficiently widened to be higher than the threshold voltage Vth as the preparation for threshold correction.

Subsequently, the threshold correction (Vth correction) is performed. Here, an example in which the threshold correction is performed four times as periods LT3a to LT3d is cited.

First, the first threshold correction (Vth correction) is performed in the period LT3a.

In this case, the write scanner 13 sets the scanning pulse WS to be the H-level and the drive scanner 12 sets the power supply pulse DS to be the drive voltage Vcc at the timing when the signal line voltage is in the reference voltage Vofs. An equivalent circuit is shown in FIG. 6B, and the anode (Node ND2) of the organic EL device 1 will be the source of the drive transistor Td through which current flows in this case. Therefore, a source node is increased while the gate (node ND1) of the drive transistor Td is fixed to the reference voltage Vofs.

The current of the drive transistor Td is used for charging the storage capacitor Cs and the capacitor Coled as long as the anode potential (potential of the node ND2) of the organic EL device 1 is lower than Vcat+Vthel (threshold voltage of the organic EL device 1). “As long as the anode potential of the organic EL device 1 is lower than Vcat+Vthel” means that leak current of the organic EL device 1 is considerably lower than the current flowing in the drive transistor Td.

Accordingly, the potential of the node ND2 (source potential of the drive transistor Td) is increased with time.

The threshold correction is basically defined as an operation of allowing the gate-source voltage of the drive transistor Td to be the threshold voltage Vth. Therefore, the source potential of the drive transistor Td should be increased until the gate-source voltage of the drive transistor Td reaches the threshold voltage Vth.

However, the gate node is fixed to the reference voltage Vofs only in the period when the signal line voltage is equal to Vofs. It is difficult to take sufficient time for increasing the source potential until the gate-source voltage reaches the threshold voltage Vth by performing the threshold correction operation once, depending on a frame rate and the like. Therefore, the threshold correction is performed plural times by being divided.

Accordingly, the threshold correction as the period LT3a is completed before the signal line voltage is equal to the video signal voltage Vsig. That is, the write scanner 13 sets the scanning pulse WS to be the L-level once and turns off the sampling transistor Ts.

As both the gate and the source are in a floating state at this time, current flows between the drain and the source in accordance with the gate-source voltage Vgs and bootstrap occurs. That is, the gate voltage and the source voltage are increased as shown in the drawing.

Next, the second threshold correction is performed in the period LT3b. That is, when the signal line voltage is equal to the reference voltage Vofs, the write scanner 13 sets the scanning pulse WS to be the H-level again to turn on the sampling transistor Ts. Accordingly, the gate voltage of the drive transistor Td becomes equal to the reference voltage Vofs and the source potential is increased again.

The threshold correction operation pauses again. As the gate-source voltage of the drive transistor Td becomes more close to the threshold voltage Vth by the second threshold correction, the bootstrap amount in the second pause period is smaller than in the first pause period.

The third threshold correction is further performed in the period LT3c, and the fourth threshold correction is performed in the period LT3d through a pause again.

Finally, the gate-source voltage of the drive transistor Td becomes the threshold voltage Vth.

At this time, the source potential (node ND2: the anode potential of the organic EL device 1) is equal to Vofs−Vth≦cat+Vthel. (Vcat represents the cathode potential and Vthel represents the threshold voltage of the organic EL device 1).

In the case of FIG. 4, after the period LT3d as the fourth threshold correction, the scanning pulse WS is set to be the L-level and the sampling transistor Ts is turned off to complete the threshold correction operation.

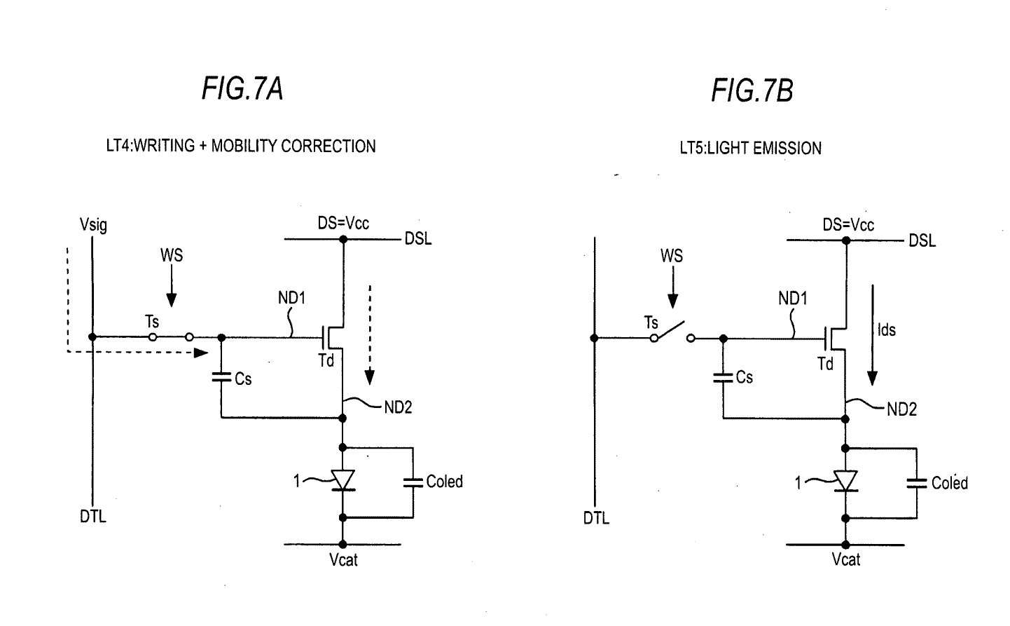

After that, the write scanner 13 sets the scanning pulse WS to be the H-level in a period LT4 in which the signal line voltage is in the video signal voltage Vsig, where writing of the video signal voltage Vsig and mobility correction are performed. That is, the video signal voltage Vsig is inputted to the gate of the drive transistor Td. An equivalent circuit at this time is shown in FIG. 7A.

The gate potential of the drive transistor Td is in the video signal voltage Vsig but the power supply control line DSL is in the drive voltage Vcc, which allows current to flow, and the source potential is increased with time.

At this time, the current flowing in the drive transistor Td is used for charging the storage capacitor Cs and the capacitor Coled as long as the source voltage of the drive transistor Td does not exceed the sum of the threshold voltage Vthel and the cathode voltage Vcat of the organic EL device 1. That is, the condition is that leak current of the organic EL device 1 is considerably lower than the current flowing in the drive transistor Td.

At this point, the threshold correction operation of the drive transistor Td has been completed, therefore, the current flowing in the drive transistor reflects the mobility μ.

Specifically, the current amount at this point is higher when the mobility is high and the source is increased earlier. Conversely, the current amount is lower when the mobility is low and the source is increased slowly.

Accordingly, in the period LT4 in which the scanning pulse WS is in the H-level, the source voltage Vs of the drive transistor Td is increased after the sampling transistor Ts is turned on, and the source voltage Vs will be a voltage Vs0 reflecting the mobility μ when the sampling transistor Ts is turned on. The gate-source voltage of the drive transistor Td is reduced by reflecting the mobility (Vgs=Vsig−Vs0) to be a voltage correcting the mobility after a fixed period of time passes.

As described above, the gate-source voltage Vgs is fixed after writing the video signal voltage Vsig and correcting the mobility, then, the operation proceeds to the bootstrap and the light emitting state (period LT5). An equivalent circuit is shown in FIG. 7B.

That is, the scanning pulse WS is set to be the L-level and the sampling transistor Ts is turned off to complete the writing, which causes the organic EL device to emit light. In this case, the current Ids corresponding to the gate-source voltage Vgs of the drive transistor Td flows, and the potential of the node ND2 is increased to a voltage VEL at which the current flows in the organic EL device 1, as a result, the organic EL device 1 emits light. At this time, the sampling transistor Ts is in the off-state and the gate of the drive transistor Td (Node ND1) is also increased at the same time with the potential increase of the node ND2, therefore, the gate-source voltage Vgs is maintained to be constant (bootstrap operation).

As described above, operations for light emission of the organic EL device 1 including the threshold correction operation and the mobility correction operation are performed in the pixel circuit 10 as the light emission drive operations of one cycle in one frame period.

According to the threshold correction operation, current corresponding to the signal potential Vsig can be given to the organic EL device 1 regardless of variations of the threshold voltage Vth of the drive transistors Td in respective pixel circuits 10, variations of the threshold voltage Vth with time and so on. That is, variations of the threshold voltage Vth on the manufacture or variations with time are cancelled, thereby maintaining high image quality without occurrence of luminance nonuniformity on the screen.

As the drain current varies also due to the mobility of the drive transistor Td, the image quality is reduced due to variations of the mobility of the drive transistors Td of respective pixel circuit 10. However, the source potential Vs in accordance with the mobility size of the drive transistors Td can be obtained by the mobility correction. Consequently, the gate-source voltage Vgs is adjusted in the event so as to absorb variations of the mobility of the drive transistors Td in respective pixel circuits 10, therefore, the reduction of image quality due to variations of the mobility can be also suppressed.

The reason that the threshold correction operation is performed plural times by being divided as the pixel circuit operation of one cycle is for responding to the request for speeding up (higher-frequency) of the display device.

As the frame rate becomes higher, operation time of the pixel circuit becomes relatively short, therefore, it is difficult to secure the continuous threshold correction period (period of the signal line voltage=the reference voltage Vofs). Accordingly, the threshold correction operations are performed in the time sharing manner as described above, thereby securing periods necessary for the threshold correction period, which allows the gate-source voltage of the drive transistor Td to converge on the threshold voltage Vth.

The correction with respect to variations in the threshold voltage and the mobility is basically made by the above operations, however, the correction is sometimes insufficient in the whole pixels.

For example, concerning the mobility correction, the period length of the period LT4 of FIG. 4 is determined by the pulse width of the scanning pulse WS. However, the optimum period of time for the mobility correction (period length of the period LT4) differs according to the mobility size. Therefore, it is necessary to adjust the mobility correction time in each pixel for making the mobility correction most suitably. Particularly, in the case of the driving of FIG. 4, the period LT4 by the pulse width of the scanning pulse WS can be adjusted row by row, however, it is difficult to perform adjustment pixel by pixel.

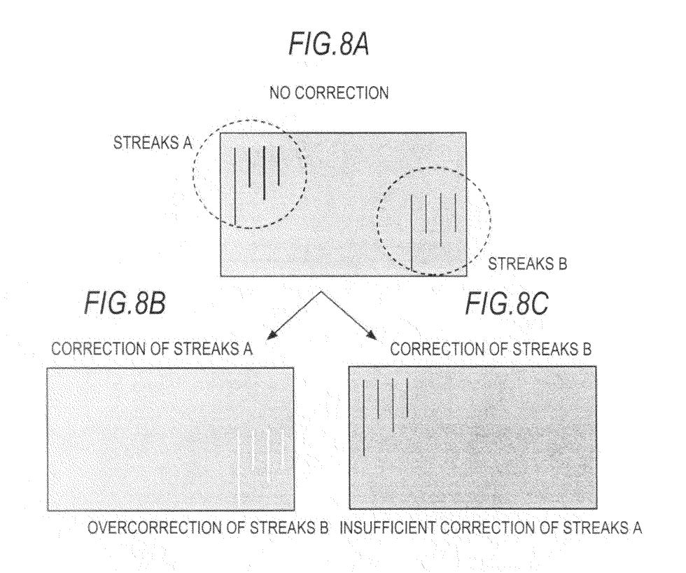

FIG. 8A shows a case in which streaks caused by difference of mobility in respective pixels in the panel surface exist at more than two places.

There exists the optimum correction time during which the streaks are eliminated in each pixel, however, streaks occur as shown in the drawing unless a certain period length of mobility correction is set to the time in which correction can be made in all pixels.

Here, assume that the mobility of pixels in which streaks occur is higher in streaks A than in streaks B. Then, when the optimum correction time is adjusted so as to fit the streaks A for correcting the streaks A, the streaks B in the pixels having higher mobility will be overcorrected, as a result, brightness of the streaks is inverted and the streaks B are not completely eliminated as shown in FIG. 8B. Conversely, when the correction time is adjusted so as to fit the streak B, the streaks A are not sufficiently corrected, as a result, the streaks A are not completely eliminated as shown in FIG. 8C.

As described above, when plural streaks exist in the panel surface as well as mobility variations thereof are large, it is difficult to correct all streaks all at once.

For responding to large variations of mobility in respective pixels as the above, it is necessary to set the optimum correction time in each pixel.

Also concerning the threshold correction operation, it is sometimes necessary to set the correction time so as to correspond to characteristics in respective pixels.

In order to suitably set the correction time in respective pixels, the second write scanner 14 and the second write control lines vWSL are provided as well as two sampling transistors Ts1, Ts2 are provided in each pixel circuit 10 in the present embodiment.

### 3. First Embodiment

In the first embodiment, mobility can be corrected so as to correspond to mobility variations described in FIGS. 8A to 8C.

As described in FIG. 1 and FIG. 2, the display device according to the embodiment is provided with the second sampling transistor Ts2 in the pixel circuit 10 in addition to the components of the above comparative example, and further provided with the second write scanner 14 and the second write control line vWSL for controlling ON/OFF of the sampling transistor Ts2.

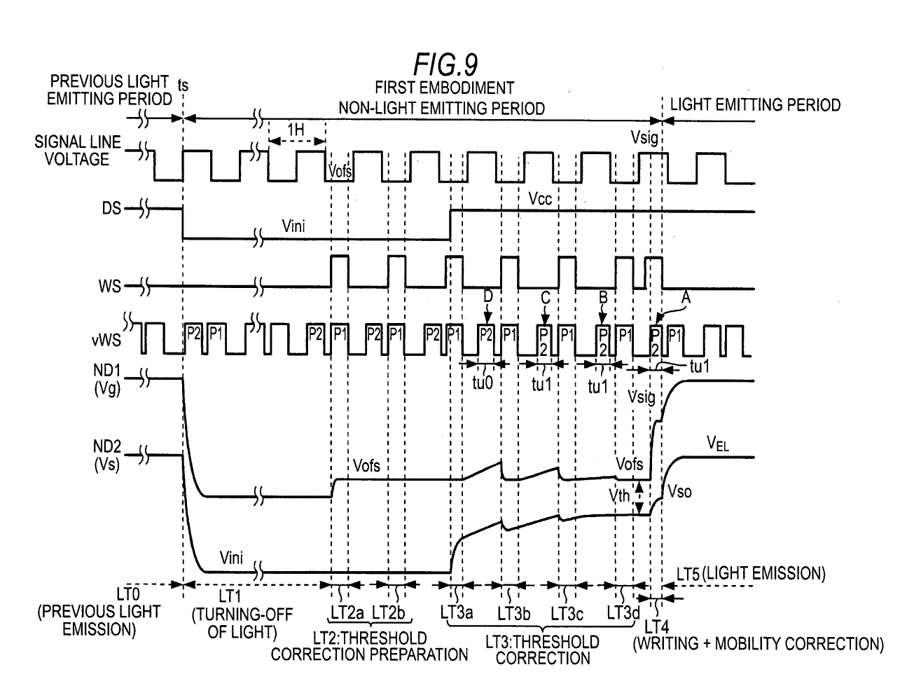

FIG. 9 shows a timing chart of operations of one cycle (one frame period) in a certain pixel circuit 10 in the same manner as FIG. 4. In this case, voltages of the signal line DTL, the power supply pulse DS and the nodes ND1, ND2 are shown in the same manner as FIG. 4. Concerning scanning pulses, the first scanning pulse WS by the first write scanner 13 and the second scanning pulse vWS by the second write scanner 14 are shown.

The signal line voltages and the power supply pulse DS are the same as FIG. 4.

The first scanning pulse WS is given to a gate of the sampling transistor Ts1 by the first write scanner 13 through the first write control line WSL. The n-channel sampling transistor Ts1 becomes conductive when the first scanning pulse WS is in the H-level and becomes nonconductive when the first scanning pulse WS is in the L-level.

The second scanning pulse vWS is given to a gate of the sampling transistor Ts2 by the first write scanner 14 through the second write control line vWSL. The n-channel sampling transistor Ts2 becomes conductive when the second scanning pulse vWS is in the H-level and becomes nonconductive when the second scanning pulse vWS is in the L-level.

Here, the second pulse vWS has two H-level pulses in 1H period as shown in the drawing. For convenience of explanation, a pulse portion which becomes in the H-level when the signal line voltage is in the reference voltage Vofs is referred to as a pulse P1, and a pulse portion which becomes in the H-level when the signal line voltage is in the video signal voltage Vsig is referred to as a pulse P2.

Operations in one cycle will be explained.

A time point “ts” in the timing chart of FIG. 9 is a start timing of one cycle in which the organic EL device 1 as the light emitting device is driven to emit light, for example, one frame period of image display.

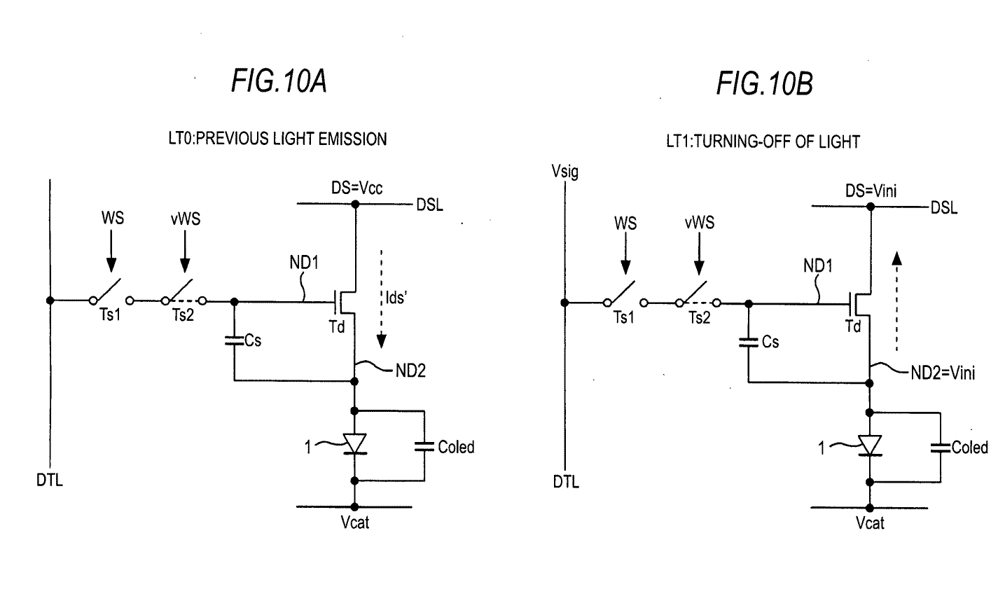

In a period before reaching the time point “ts” (period LT0), light emission in the previous frame is performed. An equivalent circuit in the period LT0 is shown in FIG. 10A.

That is, a light emitting state of the organic EL device 1 is a state in which the power supply pulse DS is in the drive voltage Vcc and the sampling transistor Ts1 is turned off. As the pulses P1, P2 are outputted in each horizontal period as the second scanning pulse vWS, the sampling transistor Ts2 is turned on/off twice in each one horizontal period. However, the sampling transistor Ts1 is in the off-state, the node ND1 is disconnected from the signal line DTL.

At this time, the drive transistor Td is set to operate in the saturation region, therefore, the current “Ids′” flowing in the organic EL device 1 will be the value shown in the above expression (1) in accordance with the gate-source voltage Vgs of the drive transistor Td.

At the time point “ts”, operations for light emission in the present frame are started.

First, the power supply pulse DC is applies in the initial potential Vini. FIG. 10B shows an equivalent circuit in a period LT1.

At this time, the initial potential Vini is smaller than the sum of the threshold voltage Vthel and the cathode voltage Vcat of the organic EL device 1, namely, Vini≦Vthel+Vcat, therefore, the organic EL device 1 is turned off and a non-light emitting period is started. At this time, the power supply control line DSL is the source of the drive transistor Td. The anode of the organic EL device 1 (node ND2) is charged to be the initial potential Vini.

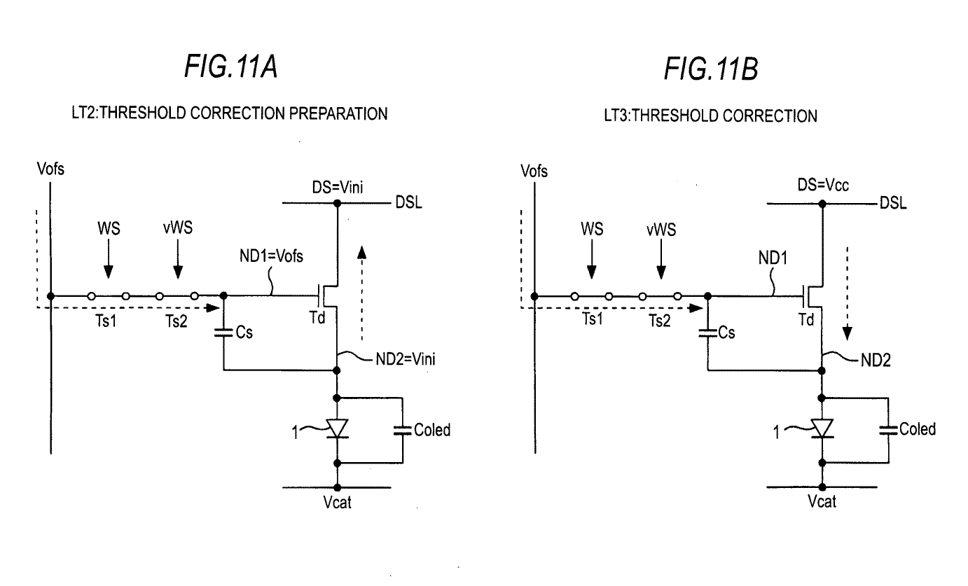

After a fixed period of time, a preparation for threshold correction is made (periods LT2a, LT2b). An equivalent circuit thereof is shown in FIG. 11A.

That is, in the periods LT2a, LT2b, the first scanning pulse WS is the H-level and the sampling transistor Ts1 is turned on when the potential of the signal line DTL is in the reference voltage Vofs. The second scanning pulse vWS (pulse P1) is in the H-level in synchronization with this, and the sampling transistor Ts2 is also turned on.

Accordingly, the gate of the drive transistor Td (node ND1) is in the reference voltage Vofs.

The gate-source voltage of the transistor Td will be Vgs=Vofs−Vini.

It is difficult to perform the threshold correction operation unless Vofs-Vini is higher than the threshold voltage Vth of the drive transistor Td, therefore, the initial voltage Vini and the reference voltage Vofs are set so that Vofs-Vini is higher than Vth. That is, the gate-source voltage of the drive transistor is sufficiently widened to be higher than the threshold voltage Vth as the preparation for threshold correction.

Subsequently, the threshold correction (Vth correction) is performed. Here, an example in which the threshold correction is performed four times as periods LT3a to LT3d is cited in the same manner as in the above comparative example.

First, the first threshold correction (Vth correction) is performed in the period LT3a.

In this case, the first write scanner 13 sets the first scanning pulse WS to be the H-level at the timing when the signal line voltage is in the reference voltage Vofs. The second write scanner 14 also sets the second scanning pulse vWS to be the H-level (pulse P1). The drive scanner 12 sets the power supply pulse DS to be the drive voltage Vcc.

An equivalent circuit is shown in FIG. 11B, and the anode (node ND2) of the organic EL device 1 will be the source of the drive transistor Td through which current flows in this case. Therefore, the source node is increased while the gate (node ND1) of the drive transistor Td is fixed to the reference voltage Vofs.

The current of the drive transistor Td is used for charging the storage capacitor Cs and the capacitor Coled as long as the anode potential (potential of the node ND2) of the organic EL device 1 is lower than Vcat+Vthel (threshold voltage of the organic EL device 1). “As long' as the anode potential of the organic EL device 1 is lower than Vcat+Vthel” means that leak current of the organic EL device 1 is considerably lower than the current flowing in the drive transistor Td.

Accordingly, the potential of the node ND2 (source potential of the drive transistor Td) is increased with time.

Next, the threshold correction as the period LT3a is completed before the signal line voltage is equal to the video signal voltage Vsig. That is, the first write scanner 13 sets the first scanning pulse WS to be the L-level once and turns off the sampling transistor Ts1 to pause the threshold correction. The pulse P1 of the second scanning pulse vWS also becomes in the L-level.

As both the gate and the source are in a floating state at this time, current flows between the drain and the source in accordance with the gate-source voltage Vgs and bootstrap occurs. That is, the gate voltage and the source voltage are increased as shown in the drawing. During the pause period, there is a period in which the sampling transistor Ts2 is turned on by the pulse P2 of the second scanning pulse vWS, however, the floating state of the node ND1 is maintained as the sampling transistor Ts1 is in the off-state.

Next, the second threshold correction is performed in the period LT3b. That is, when the signal line voltage is equal to the reference voltage Vofs, the first and second scanning pulses WS, vWS become in the H-level again and the sampling transistors Ts1, T2 are turned on. Accordingly, the gate voltage of the drive transistor Td becomes equal to the reference voltage Vofs and the source potential is increased.

The threshold correction operation pauses again. As the gate-source voltage of the drive transistor Td becomes more close to the threshold voltage Vth by the second threshold correction, the bootstrap amount in the second pause period is smaller than in the first pause period.

The third threshold correction is further performed in the period LT3c, and the fourth threshold correction is performed in the period LT3d through a pause again.

Finally, the gate-source voltage of the drive transistor Td becomes the threshold voltage Vth.

At this time, the source potential (node ND2: the anode potential of the organic EL device 1) is equal to Vofs−Vth≦cat+Vthel (Vcat represents the cathode potential and Vthel represents the threshold voltage of the organic EL device 1).

In the case of FIG. 9, after the period LT3d as the fourth threshold correction, the first scanning pulse WS is set to be the L-level and the sampling transistor Ts is turned off to complete the threshold correction operation.

The example in which the threshold correction is performed four times is applied in this case, however, how many times the threshold correction operation should be performed by being divided is determined in accordance with the configuration, the operation, the frame rate and so on of the display device, and for example, the number of times of the correction may be twice, three times or more than five times. Naturally, there is a case in which the correction is performed once without dividing.

After that, the write scanner 13 sets the scanning pulse WS to be the H-level in a period in which the signal line voltage is in the video signal voltage Vsig.

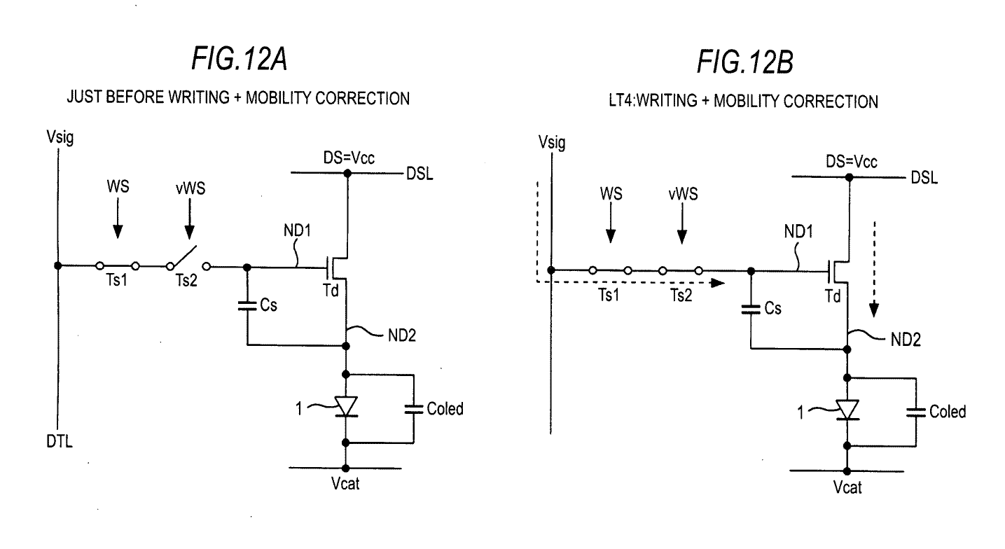

In the case of FIG. 9, the circuit is in the state shown in FIG. 12A. That is, the sampling transistor Ts1 is turned on, however, the sampling transistor Ts2 is in the off-state and writing of the video signal voltage Vsig is not started yet.

After that, the second write scanner 14 sets the second scanning pulse vWS (pulse P2) to be the H-level. According to the above, the node ND1 is connected to the signal line DTL as shown in FIG. 12B, and the writing of the video signal voltage Vsig and mobility correction are performed in the period LT4. That is, the video signal voltage Vsig is inputted to the gate of the drive transistor Td. That is, the period LT4 in which the writing of the video signal voltage Vsig and mobility correction are performed is determined by AND condition of the first scanning pulse WS and the second scanning pulse vWS.

The gate potential of the drive transistor Td is in the potential of the video signal voltage Vsig in the period LT4, and the power supply control line DSL is in the drive voltage Vcc, therefore, current flows and the source potential is increased with time.

At this time, the current of the drive transistor Td is used for charging the storage capacitor Cs and the capacitor Coled as long as the source voltage of the drive transistor Td does not exceed the sum of the threshold voltage Vthel and the cathode voltage Vcat of the organic EL device 1.

At this point, the threshold correction operation of the drive transistor Td has been completed, therefore, the current flowing in the drive transistor reflects the mobility μ. Specifically, the current amount at this point is higher when the mobility is high and the source is increased earlier. Conversely, the current amount is lower when the mobility is low and the source is increased slowly.

Accordingly, the source voltage Vs of the drive transistor Td is increased in the period LT4 and the source voltage Vs will be a voltage Vs0 reflecting the mobility μ. The gate-source voltage Vgs of the drive transistor Td is reduced by reflecting the mobility (Vgs=Vsig−Vs0) to be a voltage for correcting the mobility after a fixed period of time passes.

As described above, the gate-source voltage Vgs is fixed after writing the video signal voltage Vsig and correcting the mobility, then, the operation proceeds to the bootstrap and the light emitting state (period LT5).

That is, the scanning pulse WS is allowed to be the L-level and the sampling transistor Ts1 is turned off to complete the writing, which causes the organic EL device to emit light. In this case, the current Ids corresponding to the gate-source voltage Vgs of the drive transistor Td flows, and the potential of the node ND2 is increased to a voltage VEL at which the current flows in the organic EL device 1, as a result, the organic EL device 1 emits light. At this time, the sampling transistor Ts1 is in the off-state and the gate of the drive transistor Td (Node ND1) is also increased at the same time with the potential increase of the node ND2, therefore, the gate-source voltage Vgs is maintained to be constant (bootstrap operation).

As described above, operations for light emission of the organic EL device 1 including the threshold correction operation and the mobility correction operation are performed in the pixel circuit 10 as the light emission drive operations of one cycle in one frame period.

In the embodiment, the period LT4 in which the writing of the video signal voltage Vsig and mobility correction are performed is determined by AND condition of the first scanning pulse WS and the second scanning pulse vWS as described above.

As described above, the connection between the node ND1 and the signal line DTL is controlled by cooperation of the first scanning pulse WS and the second scanning pulse vWS, thereby adjusting the mobility correction time pixel by pixel by the pulse width of the pulse P2 of the second scanning pulse vWS (pulse P2 at the timing of shown by an arrow A of FIG. 9).

The first scanning pulse WS is supplied to the pixel circuits 10 arranged in the row direction through the write control line WSL in the row direction. Therefore, if the pulse width of the first scanning pulse WS is adjusted to adjust the time length of the period LT4, the period LT4 varies in common in plural pixel circuits 10 in the row direction. That is, it is difficult to adjust the mobility correction time pixel by pixel.

In respond to the above, the pulse width for the mobility correction by the first scanning pulse WS is fixed in the embodiment. Moreover, the pulse width of the second scanning pulse vWS supplied by each write control line vWSL in the column direction is adjusted, thereby adjusting the time length of the period LT4 (mobility correction period).

In other words, ON-period of the sampling transistor is allowed to be shorter than ON-period of the sampling transistor Ts1 when the video signal voltage Vsig is written, thereby modulating the mobility correction time selectively.

That is, it is possible to set the mobility correction time specialized to the pixel circuit 10 performing the operation of FIG. 9 by setting the pulse P2 shown by the arrow A as a pulse width “tu1”.

The second scanning pulse vWS is supplied to respective pixel circuits 10 in common, therefore, the pulse P2 shown by an arrow B of FIG. 9 sets the mobility correction time of the pixel circuit which is previous to the pixel circuit 10 performing the operation of FIG. 9 by one row in the same column. Respective pulses P2 shown by arrows C, D set the mobility correction time of the pixel circuits which are previous by two rows and three rows.

For example, the pulse widths of respective pulse P2 shown by the arrows B, C and D are tu1, tu1 and tu0 in this case. This is the case in which the same mobility correction time is set to the pixel circuit 10 which performs the operation of FIG. 9 and the pixel circuits 10 which are previous by one row and by two rows, and a different mobility correction time is set to the pixel circuit which is previous by three rows.

For example, the setting of the mobility correction time is performed as follows.

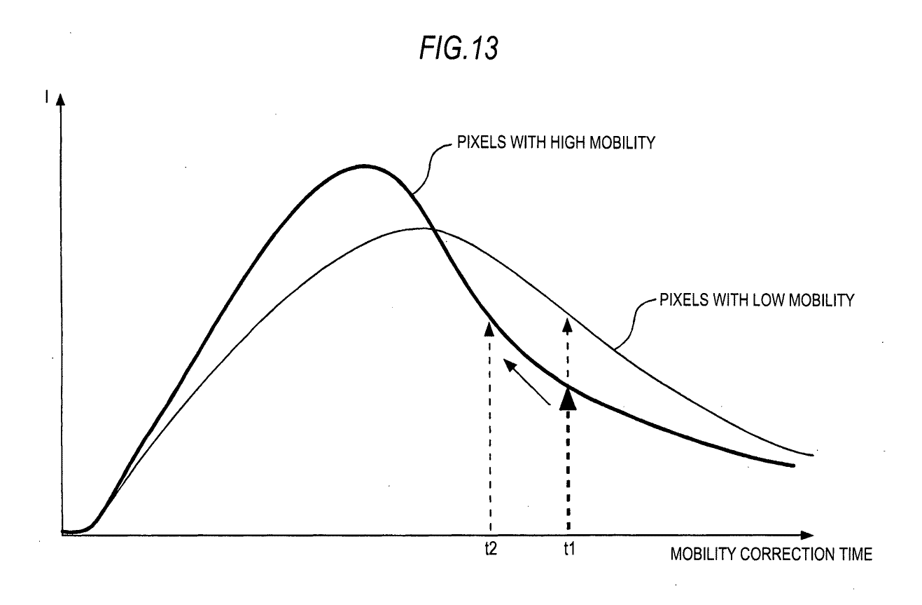

When the optimum correction time of most of streaks in the panel surface is, for example, “t1”, it is preferable that the H-level periods of both of the first scanning pulse WS and the second scanning pulse vWS for the mobility correction are the time “t1”. FIG. 13 shows characteristics between the mobility correction time and the current, which is a case where all pixels have characteristics close to pixels with low mobility.

However, in the case where there are pixels with high mobility as in the drawing, it is preferable that the pulse width of the pulse P2 of the second scanning pulse vWS is allowed to be short and ON-time of the sampling transistor Ts2 is allowed to be “t2”. Then, it is possible to align a current value of the pixel with the current value of the pixel with low mobility.

As described above, the mobility correction time of each pixel can be modulated individually as well as in an analog manner to suppress current variations.

For example, when there are plural streaks caused by large variations of mobility as shown in FIGS. 8A to 8C, the mobility correction time suitable for each pixel can be set to eliminate plural streaks.

### 4. Second Embodiment

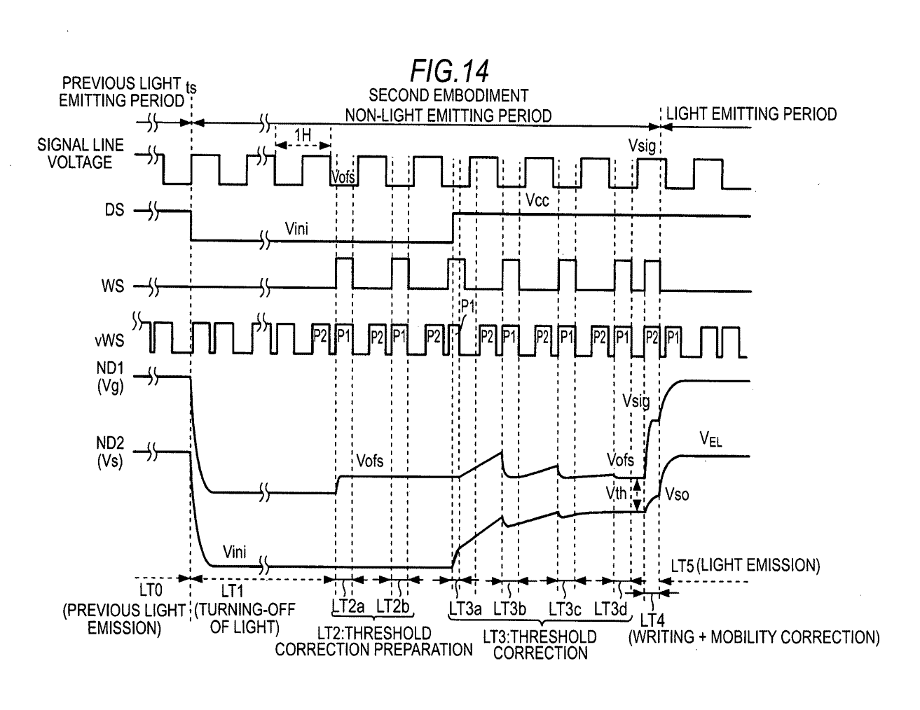

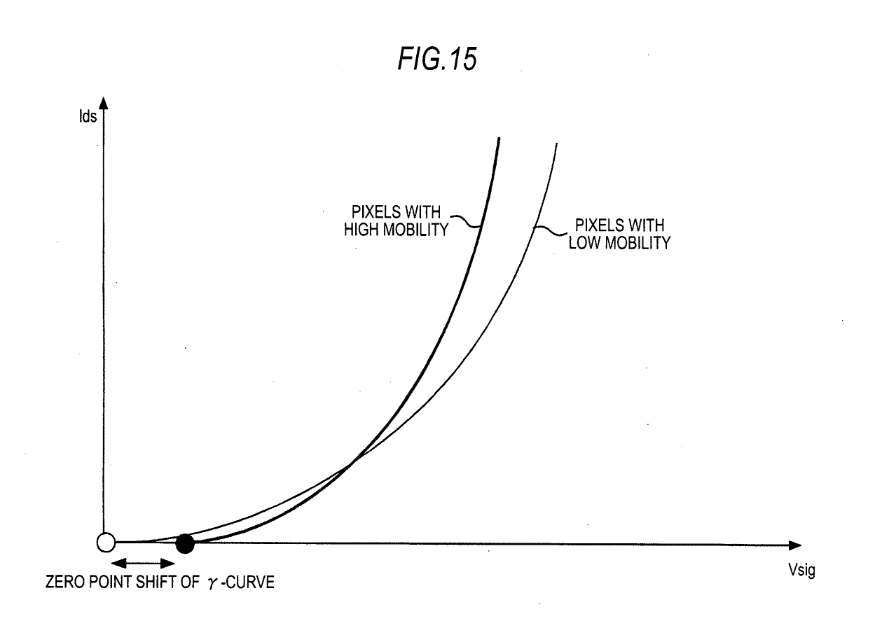

A second embodiment will be explained with reference to FIG. 14 and FIG. 15. FIG. 14 shows respective waveforms which are the same as FIG. 9.

The second embodiment is an example in which the length of the first threshold correction period is adjusted pixel by pixel to eliminate correction variations of the threshold correction operation.

The threshold correction operation is performed faster in a pixel having higher mobility of the drive transistor Td, in which the source potential reaches Vofs-Vth earlier than a pixel having lower mobility of the drive transistor Td. Strictly, if the gate-source voltage Vgs reaches the vicinity of the threshold voltage Vth, the current Ids continues flowing.

When variations of characteristics in the mobility of the respective drive transistors in the respective pixels are large, operation points after the threshold correction are shifted, as a result, a shift of a zero point in a y-curve occurs as shown in FIG. 15.

In order to eliminate variations of threshold correction due to the mobility as described above, it is effective that the threshold correction operation is promoted with respect to the pixel circuit 10 with low mobility.

Accordingly, in the pixel circuit 10 with low mobility, the pulse P1 of the second scanning pulse vWS is allows to be short so that the first threshold correction period in the period LT3a becomes shorter as shown in FIG. 14.

Basically, in the first threshold correction operation, the gate-source voltage Vgs of the drive transistor Td before the start of the correction is highest as well as the increase of the source potential is fastest.

Here, to short the first threshold correction period is allowed to be short in the pixel circuit with low mobility means that the difference of the gate-source voltage Vgs of the drive transistor Td at the point of completing the first threshold correction is increased, viewed from the relation with respect to pixels having high mobility.

In pixels with high mobility in which adjustment is not performed, the pulse widths of the first scanning pulse WS and the second scanning pulse vWS (pulse P1) are allowed to be the same as shown in the period LT3a of FIG. 9 which is the normal time length.

On the other hand, in pixels with low mobility, the width of the pulse P1 of the second scanning pulse vWS is allowed to be shorter as shown in FIG. 14 to thereby shorten the first threshold correction period (period LT3a).

As a result, in pixels with high mobility, the increase of the source voltage Vs is large and the gate-source voltage Vgs at the point of completing the first threshold correction is relatively lower. Whereas in pixels with low mobility, the first threshold correction is completed at the point when the increase of the source voltage Vs is relatively small and the gate-source voltage Vgs at that time is relatively high.

After the first threshold correction, the circuit enters the pause period, however, the source voltage Vs and the gate voltage Vg are increased by the bootstrap at this time. The bootstrap amount is increased as the gate-source voltage is higher. Therefore, the bootstrap is larger in pixels with lower mobility, which promotes the threshold correction operation. As a result, the reach of the source potential to Voft−Vth can be equivalent in respective pixel circuits regardless of the mobility size, which allows the current Ids after the threshold correction in pixels with high mobility and pixels with low mobility to be agreed with each other and can suppress the shift of the zero point in the γ-curve.

### 5. Third Embodiment

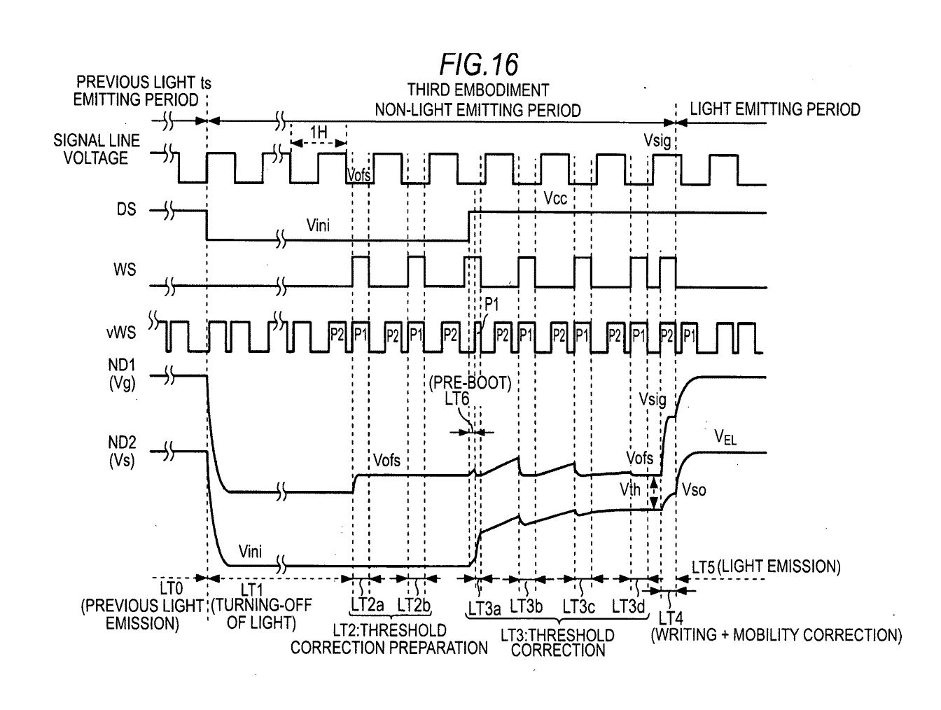

The third embodiment will be explained with reference to FIG. 16. FIG. 16 shows respective waveforms which are the same as FIG. 9 and FIG. 14.

The third embodiment is an example of eliminating correction variations of the threshold correction operation caused by mobility variations in the same manner as the second embodiment.

As can be seen from the above explanation, the period LT3a as the first threshold correction operation is a period in which the power supply pulse DS=Vcc as well as both of the first scanning pulse WS and the second scanning pulse vWS are in the H-level.

In the case of the third embodiment, the timing at which the second scanning pulse vWS rises is later than the timing at which the power supply pulse DS becomes equal to Vcc. That is, the power supply pulse DS becomes equal to Vcc just before the period LT3a as the first threshold correction operation, however, a period in which the gate of the drive transistor Td is not connected to the signal line DTL (period in which the sampling transistor Ts2 is in the off-period) is provided. The period is provided as a pre-boot period LT6.

In the pre-boot period LT6, the source voltage Vs and the gate voltage Vg are increased by the bootstrap. Then, the first threshold correction is started after the bootstrap.

The above adjustment is performed with respect to pixels with low mobility.

That is, the first threshold correction is normally performed as shown in FIG. 9 with respect to pixels with high mobility, however, the rising timing of the second scanning pulse vWS is delayed so as to provide the pre-boot period LT6 with respect to pixels with low mobility as shown in FIG. 16.

Then, in pixels with low mobility, the source voltage Vs is already increased to some degree at the point when the first threshold correction is started as well as the first threshold correction period will be short. In this case, the gate-source voltage Vgs is reduced to some degree at the time of starting the first threshold correction as well as the threshold correction period is short, therefore, the first threshold correction is completed in a state in which the increase of the source voltage Vs is relatively small. Accordingly, the gate-source voltage Vgs at the point of completing the first threshold correction is relatively high. Consequently, the bootstrap at the next pause period will be large to thereby promote the threshold correction operation in the same manner as the second embodiment.

As a result, the reach of the source potential to Voft-Vth can be equivalent in respective pixel circuits regardless of the mobility size, which allows the current Ids after the threshold correction in pixels with high mobility and pixels with low mobility to be agreed with each other and can suppress the shift of the zero point in the γ-curve.

### 6. Fourth Embodiment

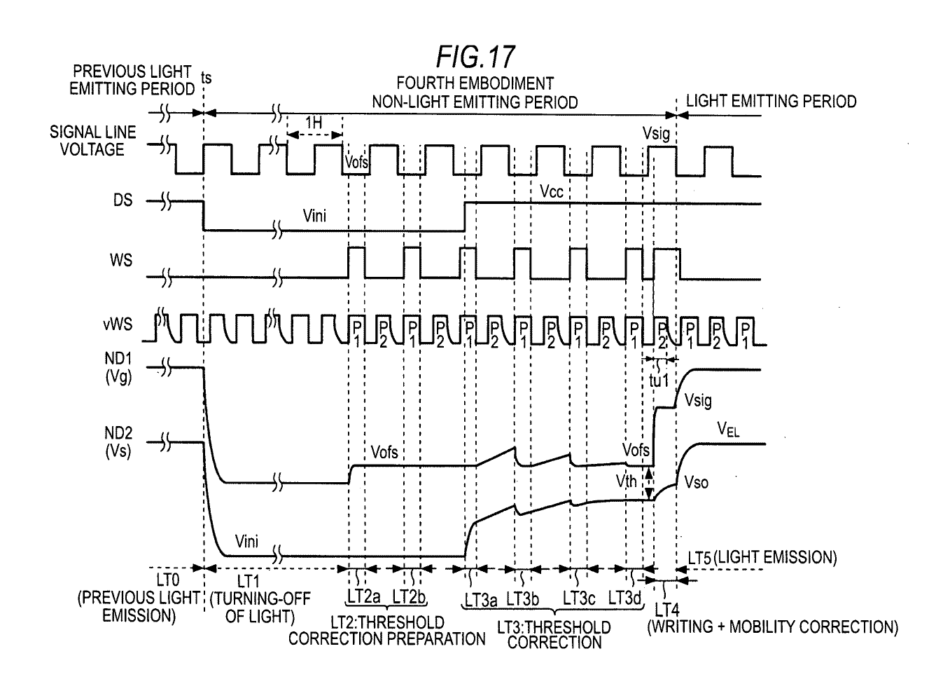

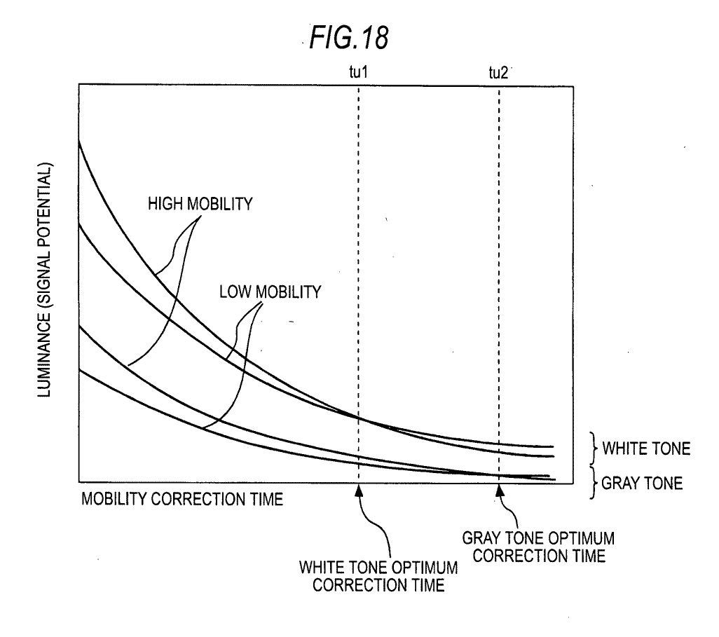

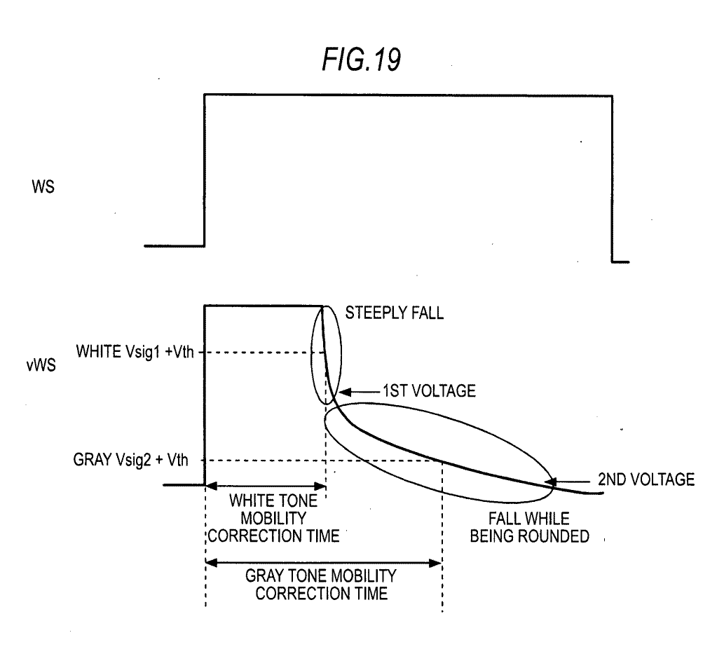

A fourth embodiment will be explained with reference to FIG. 17, FIG. 18 and FIG. 19. The embodiment is an example in which the optimum mobility correction is realized in all values (tones) of the video signal voltage Vsig by rounding the pulse for writing the video signal voltage Vsig.

As shown in FIG. 17, falling edges of pulses P2 in the second scanning pulse vWS have rounded waveforms.

The mobility correction time in each pixel circuit 10 can be individually adjusted by the H-level width of the pulse P2, for example, by a width “tu1” in the drawing. The point is the same as described in the first embodiment.

Additionally, suitable mobility correction time can be automatically obtained in respective tone values by the video signal voltage Vsig by rounding the waveform in the falling edges of the pulses P2.

The optimum mobility correction time “tu” tends to differ according to the luminance level (video signal potential Vsig) of pixels. This point will be explained with reference to FIG. 18.

In a graph of FIG. 18, the horizontal axis corresponds to the mobility correction time “tu” and the vertical axis corresponds to the luminance (signal potential). In high luminance (white tone), the luminance levels are just equivalent when “tu1” is set as the mobility correction time in the drive transistor Td with high mobility and the drive transistor Td with low mobility.

That is, the mobility correction time “tu1” is the optimum correction time when the input signal potential is the white tone. On the other hand, when the input signal potential is intermediate luminance (gray tone), there is a difference in luminance of the drive transistor Td with high mobility and the drive transistor Td with low mobility when applying the mobility correction time “tu1”, and it is difficult to make complete correction. When a correction time “tu2” which is longer than the time “tu1” is secured, luminance will be in the same level in the drive transistors with high mobility and the low mobility. Therefore, when the signal potential is the gray tone, the optimum correction time “tu2” will be longer than the optimum correction time “tu1” at the time of the white tone.

If the mobility correction time “tu” is fixed not depending on the luminance level, it is difficult to make mobility correction completely in all tones, which causes streaks. For example, when the mobility correction time “tu” is set to the optimum correction time “tu1” of the white tone, streaks remain in the screen when the input video signal is the gray tone. Conversely, when the mobility correction time “tu” is set to the optimum correction time “tu2” of the gray tone, streaks appear on the screen when the input video signal is the white tone. That is, when the mobility correction time “tu” is fixed, it is difficult to correct mobility variations of all tones from white to gray tones at the same time.

In the present embodiment, the falling of the pulse P2 of the second scanning pulse vWS is rounded as described above, thereby automatically adjusting the mobility correction period so as to be optimized in accordance with the level of the video signal voltage Vsig to be inputted.

This point will be explained in detail with reference to FIG. 19. FIG. 19 shows the first scanning pulse WS and the second scanning pulse vWS (a portion of the pulse P2).

When both the first scanning pulse WS and the second scanning pulse vWS are in the H-level, the gate of the drive transistor Td is connected to the signal line DTL and writing of the video signal voltage Vsig and the mobility correction are performed.

In the example of FIG. 19, the first scanning pulse WS and the second scanning pulse vWS rise to the H-level at the same time, and the writing and the mobility correction are started at the timing. Then, the mobility correction is completed when the second scanning pulse vWS is in the L-level.

Here, in this example, the waveform of the second scanning pulse vWS is allowed to fall steeply to a suitable potential first as shown in the drawing when the waveform of the second scanning pulse vWS falls, then, the pulse is allowed to fall to the final potential while being rounded. According to the process, it is possible to provide two or more mobility correction periods which are bounded by a tone determined by a desired potential. For convenience of explanation, the first voltage obtained by allowing the waveform to fall steeply will be referred to as a first voltage and the final voltage obtained by allowing the waveform to fall while being rounded will be referred to as a second voltage. Here, an operation of the waveform of the second scanning pulse vWS will be considered on the assumption that the first voltage=8V and the second voltage=4V as a model. Assume that the threshold voltage of the sampling transistor Ts2 is Vth (Ts2)=2V.

When the white tone Vsig1=8V is written, the sampling transistor Ts2 is cut off at a point when the second scanning pulse vWS falls to Vsig1+Vth (Ts2)=10V. That is, when Vsig=8V is applied to the source of the sampling transistor Ts2 from the signal line DTL, the sampling transistor Ts2 is cut off at a point where the gate potential of the sampling transistor Ts2 is higher than the source potential by the threshold voltage 2V. In the case of the white tone, the mobility correction time is determined from the rising timing of the second scanning pulse vWS until a point of steep falling to the first voltage.

On the other hand, when writing the gray tone Vsig2=4V, the cut-off voltage of the sampling transistor Ts2 will be Vsig2+Vth(Ts2)=6V. A point where the second scanning pulse vWS falls to the cut-off voltage 6V will be a certain timing on the way that the rounded waveform reaches to the second voltage from the first voltage. That is, the mobility correction time can be taken longer in the case of the gray tone than the mobility correction time in the case of the white tone.

When a further lower tone, for example, Vsig=3V is written, the cut-off voltage of the sampling transistor Ts2 will be 5V in the same manner and the cut-off timing is further shifted later as the waveform is rounded, which prolongs the mobility correction time.

The mobility correction time can be taken longer as the tone becomes lower.

In the embodiment, the mobility correction time can be adjusted pixel by pixel by the H-level period of the second scanning pulse vWS, in addition, the mobility correction time can be automatically adjusted in accordance with values (tone values) of the video signal voltage Vsig by rounding the falling of the waveform of the second scanning pulse vWS. Accordingly, correction of streaks can be realized positively.

The gate of the drive transistor Td is connected to the signal line DTL in the case where the sampling transistors Ts1, Ts2 are both in the on-state, and the second scanning pulse vWS is adjusted to adjust the mobility correction time pixel by pixel in the above example. Additionally, the idea of adjusting the mobility correction time according to tones by simply rounding the waveform can be realized also by rounding the falling of the first scanning pulse WS.

However, it is preferable to round the second scanning pulse vWS routed by vertical wiring (write control line vWSL) with high wiring resistance/capacity as well as with large transient.

### 7. Fifth Embodiment

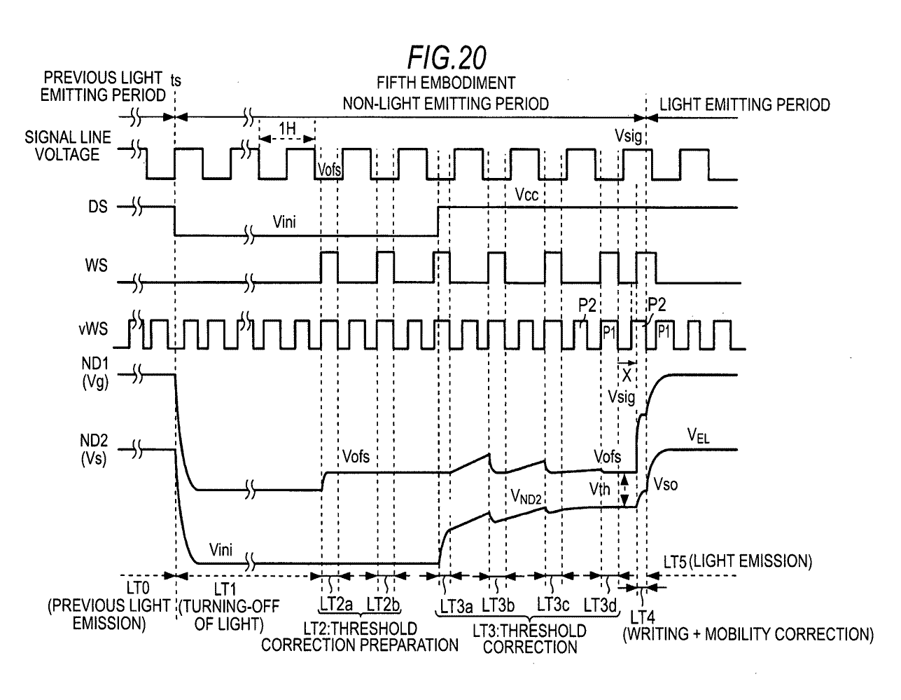

A fifth embodiment will be explained with reference to FIG. 20.

The embodiment is an example in which the start timing of the period LT4 for the writing of the video signal voltage Vsig and the mobility correction is determined by the first scanning pulse WS.

Accordingly, the second scanning pulse vWS (pulse P2) is allowed to be the H-level, then, the first scanning pulse WS is allowed to be the H-level at the time of writing the video signal voltage Vsig. That is, the gate of the drive transistor Td is connected to the signal line DTL at the time of allowing the first scanning pulse WS to be the H-level.

The timing of completing the mobility correction is preferably adjusted by the falling timing of the second scanning pulse vWS.

When the second scanning pulse vWS is allowed to rise in all pixel circuits 10 in the above manner in advance, the time length of a period X in the drawing, namely, from the timing of completing the threshold correction to the timing of starting writing of the video signal voltage Vsig can be unified in all pixels.

During the period X, minute variations are generated in voltages of respective nodes by leak current of respective transistors. Accordingly, when the period X is not unified in respective pixels, variations by leak current occur, as a result, uniformity of the whole panel can be reduced.

In respond to this, the period X can be unified in the embodiment, therefore, effects of leak current can be uniformized in respective pixel to thereby suppress the reduction of uniformity.

### 8. Sixth Embodiment

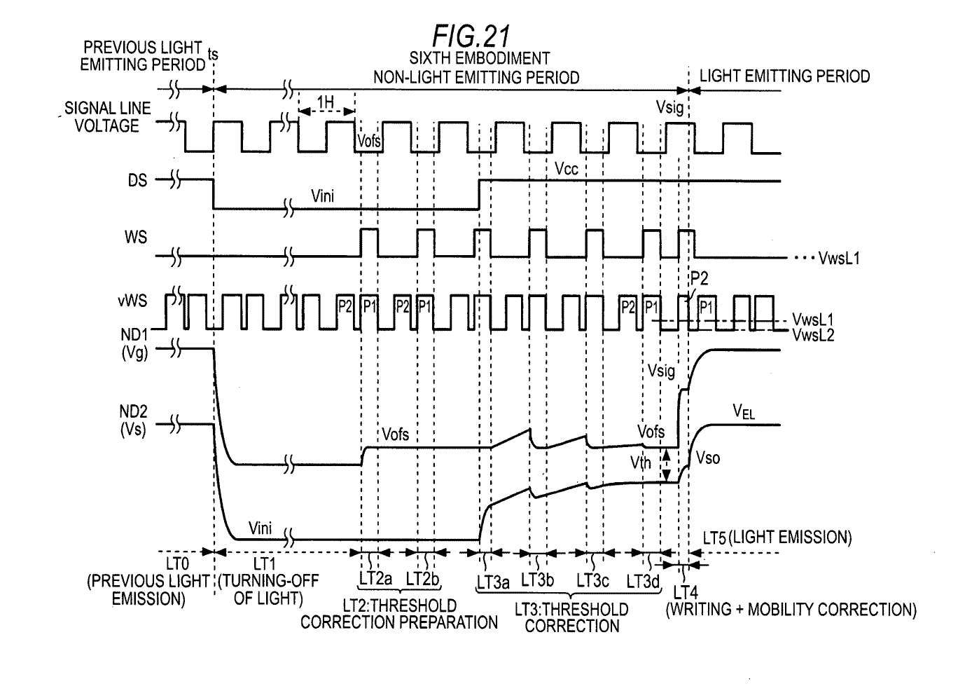

A six embodiment will be explained with reference to FIG. 21.

The embodiment is an example in which the L-level voltage of the second scanning pulse vWS is set to be lower than the L-level voltage of the first scanning pulse WS for suppressing characteristic variations of the sampling transistors Ts1, Ts2.

FIG. 20 shows an example in which the period LT4 is adjusted by the pulse width of the second scanning pulse vWS, for example, in the same manner as the first embodiment of FIG. 9. Here, assuming that the L-level voltage of the first scanning pulse WS is VwsL1 and the L-level voltage of the second scanning pulse vWS is VwsL2, VswLl is higher than VwsL2.

As can be seen from waveforms of the above respective embodiments, the sampling transistor Ts2 controlled by the second scanning pulse vWS is operated so as to repeat ON/OFF twice in one horizontal period. That is, a period of time when the sampling transistor Ts2 is in the on-state is longer than a period of time when the sampling transistor Ts1 is in the on-state.

Generally, the threshold voltage Vth of the transistor is shifted to enhancement as the on-time is longer, which causes problems such as luminance reduction.

In order to take countermeasures against the above, the sampling transistor Ts2 is negatively biased to reduce the L-level voltage thereof, thereby suppressing the shift to enhancement.

Naturally, to reduce the L-level of the second scanning pulse vWS can be applied to cases where operation of the second, third, fourth and the fifth embodiments are performed.

### 9. Modification Example

The first to sixth embodiments have been explained as the above, however, the present disclosure is not limited to the above respective examples.

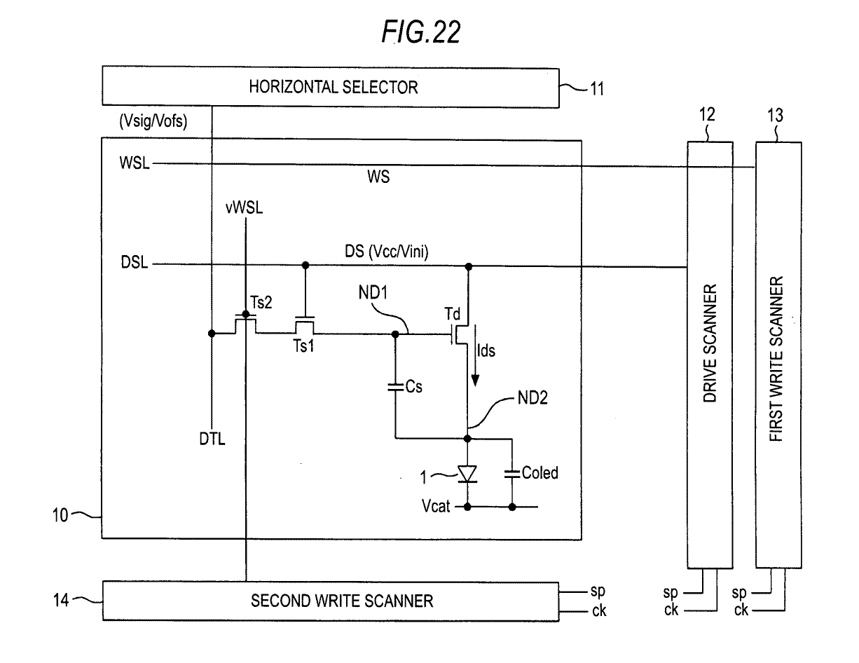

The configuration of the pixel circuit 10 is not limited to FIG. 2. For example, a configuration of FIG. 22 can be applied. The case of FIG. 2 has a configuration in which the sampling transistor Ts1 is connected on the side of the signal line DTL and the sampling transistor Ts2 is connected on the side of the node ND1, whereas in FIG. 22, a configuration in which the sampling transistor Ts2 is connected on the side of the signal line DTL and the sampling transistor Ts1 is connected on the side of the node ND1 is applied. The operations of the above examples are realized in the same manner also in the circuit configuration.

In the sampling transistor Ts2 controlled by the second scanning pulse vWS, ON/OFF are frequently switched. Then, coupling is liable to be added to the node ND1 and to affect the gate-source voltage Vgs of the drive transistor Td when the sampling transistor Ts2 is connected on the side of the node ND1 as shown in FIG. 2. When considering the point, the configuration of FIG. 22 is preferable.

As the configuration of the pixel circuit 10, for example, the sampling transistors Ts1, Ts2 can be p-channel. Naturally, control logic of the first scanning pulse WS and the second scanning pulse vWS are reversed in that case.

Furthermore, various configurations of the pixel circuit itself can be devised. The pixel circuit includes at least the organic EL device and the drive transistor Td applying current corresponding to the video signal voltage Vsig inputted with respect to the organic EL device.

The arrangement of the switching devices determining the timing of the mobility correction or the threshold correction can be devised in various manners other than the sampling transistors Ts1 and Ts2 in the embodiments.

The technology can be applied to the switching portion determining the timing of the mobility correction or the threshold correction regardless of the pixel circuit configuration. That is, two switching devices are provided and one is on/off controlled by the scanning pulse in the row direction and the other is controlled by the scanning pulse in the column direction, thereby realizing the operations of the above examples.

Combinations of the first to sixth embodiments can be naturally considered.

For example, it is also possible to apply operations described in the first and second embodiments and to execute adjustment of mobility correction time and adjustment of threshold correction variations at the same time in respective pixel circuits.

The present disclosure contains subject matter related to that disclosed in Japanese Priority Patent Application JP 2010-150797 filed in the Japan Patent Office on Jul. 1, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a pixel array in which pixel circuits each having a light emitting device and a drive transistor which applies current corresponding to an inputted video signal voltage to the light emitting device are arranged in a matrix state;
a signal selector supplying at least the video signal voltage and a reference voltage as signal line voltages to respective signal lines arranged in columns on the pixel array;
a first write scanner outputting a first scanning pulse with respect to respective first write control lines arranged in rows on the pixel array, which is used for controlling input of the signal line voltages to the pixel circuits; and
a second write scanner outputting a second scanning pulse with respect to respective second write control lines arranged in columns on the pixel array, which is used for controlling input of the signal line voltages to the pixel circuits with the first scanning pulse.

2. The display device according to claim 1,
wherein the pixel circuit having a configuration in which the drive transistor applies current corresponding to a gate-source voltage to the light emitting device when a drive voltage is applied between drain/source, further includes
a storage capacitor connected between the gate and the source of the drive transistor and storing the video signal voltage inputted from the signal line, and
first and second switching devices connected in series between the signal line and a gate node of the drive transistor, wherein
the first switching device is turned on/off by the first scanning pulse, and
the second switching device is turned on/off by the second scanning pulse.

3. The display device according to claim 2,
wherein the signal line voltages are inputted to the gate node of the drive transistor by turning on both of the first and second switching devices by the first and second scanning pulses.

4. The display device according to claim 3,
wherein, in each pixel circuit,
the video signal voltage is inputted by turning on both of the first and second switching devices by the first and second scanning pulses during a period in which the signal line voltage is in the video signal voltage, and
a period of a mobility correction operation of the drive transistor performed at the time of inputting the video signal voltage is adjusted in each pixel circuit by adjusting a length of an on-period of the second switching device by the second scanning pulse with respect to an on-period of the first switching device by the first scanning pulse.

5. A display device according to claim 3,
wherein, in each pixel circuit,
a threshold correction operation allowing the storage capacitor to store a threshold voltage of the drive transistor is performed by inputting the reference voltage to the gate node of the drive transistor when both of the first and second switching devices are turned on by the first and second scanning pulses as well as by applying the drive voltage to the drive transistor during a period in which the signal line voltage is in the reference voltage, and
an execution period of the threshold correction operation is adjusted in each pixel circuit by adjusting a length of an on-period of the second switching device by the second scanning pulse with respect to an on-period of the first switching device by the first scanning pulse.

6. The display device according to claim 3,
wherein, in each pixel circuit,
a threshold correction operation allowing the storage capacitor to store a threshold voltage of the drive transistor is performed by inputting the reference voltage to the gate node of the drive transistor when both of the first and second switching devices are turned on by the first and second scanning pulses as well as by applying the drive voltage to the drive transistor during a period in which the signal line voltage is in the reference voltage, and
a source voltage and a gate voltage of the drive transistor are increased by providing a period in which the drive voltage is applied to the drive transistor, the first switching device is in an on-state by the first scanning pulse and the second switching device is in an off-state by the second scanning pulse just before the start of the threshold correction operation.

7. The display device according to claim 3,
wherein, in each pixel circuit,
the video signal voltage is inputted by turning on both of the first and second switching devices by the first and second scanning pulses during a period in which the signal line voltage is in the video signal voltage, and
a waveform of the second scanning pulse at the time of inputting the video signal voltage is a waveform in which a timing when the second switch device is turned off varies in accordance with video signal voltage values.

8. The display device according to claim 3,
wherein, in each pixel circuit,
the video signal voltage is inputted by turning on both of the first and second switching devices by the first and second scanning pulses during a period in which the signal line voltage is in the video signal voltage, and
the input of the video signal voltage is started from a timing when the first switching device is turned on by setting timings of the first and second scanning pulses so that a timing when the second switching device is turned on is earlier than the timing when the first switching device is turned on.

9. The display device according to claim 3,
wherein a low-level voltage of the second scanning pulse is lower than a low-level voltage of the first scanning pulse.

10. A display device comprising:
a pixel array in which pixel circuits each having a light emitting device are arranged in a matrix state;
a signal selector supplying signal line voltages to respective signal lines arranged in columns on the pixel array;
a first write scanner outputting a first scanning pulse with respect to respective first write control lines arranged in rows on the pixel array, which is used for controlling input of the signal line voltages to the pixel circuits; and
a second write scanner outputting a second scanning pulse with respect to respective second write control lines arranged in columns on the pixel array, which is used for controlling input of the signal line voltages to the pixel circuits.

11. A pixel circuit comprising:
a light emitting device;
a drive transistor applying current corresponding to an inputted video signal voltage to the light emitting device;
a storage capacitor connected between the gate and the source of the drive transistor and storing the video signal voltage inputted from the signal line; and
first and second transistors connected in series between the signal line and a gate node of the drive transistor;
wherein a gate node of the first transistor is connected to gate nodes of the first transistors of the pixel circuits adjacent in the row direction, and
a gate node of the second transistor is connected to gate nodes of the second transistors of the pixel circuits adjacent in the column direction.

12. A pixel circuit comprising:
a light emitting device;
a drive transistor applying current corresponding to an inputted video signal voltage to the light emitting device;
a storage capacitor storing the voltage; and
first and second transistors connected in series between the signal line and the storage capacitor,
wherein a gate node of the first transistor is connected to gate nodes of the first transistors of the pixel circuits adjacent in the row direction, and
a gate node of the second transistor is connected to gate nodes of the second transistors of the pixel circuits adjacent in the column direction.

13. A display drive method of a display device including
a pixel array in which pixel circuits each having a light emitting device and a drive transistor which applies current corresponding to an inputted video signal voltage to the light emitting device are arranged in a matrix state,
a signal selector supplying at least the video signal voltage and a reference voltage as signal line voltages to respective signal lines arranged in columns on the pixel array,
a first write scanner outputting a first scanning pulse with respect to respective first write control lines arranged in rows on the pixel array, and
a second write scanner outputting a second scanning pulse with respect to respective second write control lines arranged in columns on the pixel array, the method comprising:
controlling input of the signal line voltages to respective pixel circuits by cooperation of the first and second scanning pulses; and
performing light-emitting drive operation of the light-emitting device by using the inputted video signal voltage and the reference voltage in respective pixel circuits.
